(19) United States
(12) Patent Application Publication
(10) Pub. No.: US 2016/0110722 A1
(43) Pub. Date: Apr. 21, 2016

(54) METHOD AND SYSTEM FOR ENABLING A SERVICE ASSOCIATED WITH A PRODUCT VIA A DIGITAL OBJECT

(71) Applicant: Warrantix, Inc., Oakbrook, IL (US)

(72) Inventors: Kanumuru Sridhar Reddy, Rakanpur (IN); Satyan G. Pitroda, Oakbrook, IL (US)

(21) Appl. No.: 14/918,909

(22) Filed: Oct. 21, 2015

Related U.S. Application Data
(60) Provisional application No. 62/066,610, filed on Oct. 21, 2014.

(51) Int. Cl. G06Q 30/00

(52) U.S. Cl. CPC G06Q 30/012

(57) ABSTRACT

A method and system for a user to utilize a service associated with a product. The method and system collects user information and product information related to the product. The user information and the product information are then transferred to a server. In response to receiving the user information and the product information, the server generates a digital object that comprises information for the user to utilize the service associated with the product. The digital object is generated to provide the user with a digital evidence of verified ownership to claim entitlements. Thereafter, the digital object is transferred to a user device and stored thereon in order for the user to manage and utilize the service associated with the product.

### RELATED APPLICATIONS

This application is a non-provisional of U.S. provisional application 62/066,610, filed Oct. 21, 2014, and which is hereby incorporated by reference in its entirety.

### FIELD

The disclosure generally relates to providing services associated with products, including physical products. More specifically, the disclosure relates to utilizing digital objects associated with products that provide a variety of functions, including enabling certain particular services, such as warranty services and insurance services, related to the products.

### BACKGROUND

When a user purchases a product, the user typically has an obligation to mail filled-in warranty cards to product manufacturers for the warranty to take effect. The user can also register a product purchased online in order to take advantage of post-product purchase services such as in-warranty entitlements and after sales support. The post-product purchases can also include services such as, but not limited to, product recall, product updates and post-warranty replacement sale offers for the product purchased. In most cases, the user fails to extend a warranty, or the user, while purchasing an extended warranty, is unaware of entitlement limitations and information related to alternative service provider offerings, for example, an extended warranty in order to enjoy continued warranty entitlement services or other beneficial services associated with the product. The only documentary evidence users have to claim entitlements is typically the purchase bill of the product or extended services. Even the warranty cards that are meant to be filled-in and sent to the manufacturer are rarely sent to the manufacturer by the user.

With hundreds of products being purchased by the user, the aforementioned tasks often become difficult to manage. The failure to undertake various steps may result in losing a warranty, a rebate, other product benefits or loss of potential discounts/savings and time.

Furthermore, sectors such as the durable goods sector have been affected by a lack of connection between the manufacturer or Original Equipment Manufacturer (OEM) and the Customer. Due to lack of a connection, customer relationship management for this sector is in its infancy, due to the absence of dedicated dealerships for durable goods. Even the automotive sector, which has strong dedicated dealer networks, also has serious issues with customer retention due to a lack of one-on-one customer relationships and sustained dialog with customers.

The only connection between the OEM and customer has been through the use of outdated technologies such as call centre, email, and text messaging, technologies which are also usually affected by spamming. Services sectors such as consumer insurance are also facing similar consumer connect and dialog issues.

Therefore, there is a need for a method and system for enabling users to have sufficient evidence of product ownership, purchase related details, services entitlement information and related processes to efficiently manage post-purchase and reverse logistics customer relationship management services associated with a product.

### SUMMARY

Provided herein are methods and systems for providing a secure digital object, the secure digital object containing product information and purchaser information received following the purchase of the product, such as from a point of sale device, by the purchaser and containing service information for services, such as warranty services and insurance services, and other services, associated with the product; and a wrapper for the secure digital object, the wrapper providing security for the digital object and being adapted for delivery of the digital object to at least one of a device and an account of the purchaser and for management of access to the service by the purchaser using at least one of the device and the account. The secure digital object may be a read-only electronic data structure that represents a product, including physical characteristics of the product. The secure digital object can be transferred from user to user, such as in the case of the transfer of the product to which the service relates. The secure digital object may provide a read-only electronic data structure that is permanently associated with the purchase of a product, the purchaser (and optionally subsequent purchasers) and one or more services, such as warranties, that are associated with the product.

Further provided herein are methods and systems disclosing an article including a secure digital object. In embodiments, the secure digital object may contain product information and purchase information received from a point of sale facility following the purchase of the product by the purchaser. The secure digital object may contain service information for a service associated with the product. The article may additionally include a wrapper for the secure digital object. The wrapper may provide security for the digital object. In embodiments, the wrapper may be adapted for delivery of the digital object to at least one of a device and an account of the purchaser and for management of access to the service by the purchaser using at least one of the device and the account. In embodiments, the secure digital object may exist in an ecosystem which extends the customer relationship connection of the purchaser.

One embodiment is a method. The method includes steps of receiving user information of a user and product information of a product collected at a point of sale; storing the user information and product information; generating a digital object based on the user information and the product information, wherein the digital object comprises information for using a service associated with the product. The method also includes a step of transferring the digital object to a user device, the digital object thereby adapted to transform an electronic data structure of the user device such that the user device operates as a token of ownership of the product by the user and as an authenticated access token for a service associated with the product. In embodiments, the electronic data structure includes two or more items selected from the group consisting of a warranty, a service history, a product manual, an invoice, a cryptographic key and product related media.

In another embodiment, the step of receiving the user information includes at least one of receiving a manual input corresponding to the user information collected at the point of sale and receiving the user information from the user device via at least one of near field communication, Wi-Fi, and iBeacon™. In another embodiment, product information is received by at least one of receiving a manual input corresponding to the product information collected at the point of sale and receiving an identifier corresponding to the product, the identifier collected at the point of sale.

In another embodiment, generating the digital object associates the product with a user account, wherein the product is associated with the user account based on the user information received at the point of sale. In another embodiment, generating the digital object comprises validating the user information and the product information. In another embodiment, generating the digital object comprises encapsulating the digital object in a secured digital wrapper.

In another embodiment, transferring the digital object to the user device comprises unwrapping the digital object at the user device and storing the information obtained from the digital object in a data storage facility of the user device. In another embodiment there is a further step of synchronizing the information stored on the user device with a user account hosted in a cloud computing environment.

In another embodiment, the service associated with the product is a warranty service. In another method, there is a further step of presenting the warranty service and a warranty information associated with the product to at least one of the user device and the user account. In another method, there is a further step of transferring the warranty associated with the product to a second user, wherein transferring the warranty comprises transferring the digital object from the user device to a second user device associated with the second user.

In another method, there is a further step of transferring the warranty associated with the product to a second user, wherein transferring the warranty comprises transferring the digital object from the user device to a second user device associated with the second user and wherein transferring the warranty associated with the product to the second user functions as a transfer of ownership of the product to the second user.

In another method, there is a further step of updating a database of a stakeholder associated with the product in response to the transfer of the warranty to the second user. In one method, the stakeholder is selected from the group consisting of a manufacturer, a warranty service provider, an entitlement service provider, a repair provider, a vendor and an insurance company.

Another embodiment includes the step of presenting at least one of an extended warranty and an additional entitlement from a service provider. In another method, there is a further step of updating the digital object with the information associated with the purchase of at least one of the extended warranty and the additional entitlement. In another method, there is a further step of updating a database of a stakeholder associated with the product in response to the purchase of one of the extended warranty and the additional entitlement. In one method, the stakeholder is selected from the group consisting of a manufacturer, a warranty service provider, an entitlement service provider, a repair provider, a vendor and an insurance company. Another embodiment includes a further step of connecting with a product reverse logistics process using the warranty service.

In another method, the user information and product information is stored at a secure server of a manufacturer of the product. In another method, access is granted to a merchant or a product service provider to the user information and product information stored at the secure server of the manufacturer of the product.

Another embodiment is a method. The method includes steps of accepting a user information and a product information from the user via a user device, wherein the user information and the product information is accepted at a point of sale; generating a digital object based on the user information and the product information, wherein the digital object comprises information for the user to utilize the service associated with the product; and transferring the digital object to the user device to allow the user to utilize the service associated with the product.

In another embodiment, the accepted user information and product information is stored at a secure server of a manufacturer of the product. In another embodiment, an app plug is accepted into the user device before transferring the digital object to the user device. In another embodiment, the service associated with the product includes a digital warranty for the product and further includes, after the step of transferring, downloading to the digital object at least one of a remote control program for the product, a video or media presentation concerning the product and a support Wizard for the product.

Another embodiment is a system. The system includes a user device configured to send a user information to a point of sale device at a time of purchase of the product; and a point of sale device configured to: collect the user information; collect a product information at the time of purchase of the product; and generate a digital object based on the user information and the product information, wherein the digital object comprises information for the user to utilize the service associated with the product; and transfer the digital object to the user device for utilizing the service associated with the product, wherein transferring the digital object to the user device also transfers ownership of the product to the user.

In another embodiment, the digital object is a Binary Large Object (BLOB). Another embodiment includes a digital object that is configured to automatically unwrap when placed in a digital container of the user device, wherein the digital container comprises an authentic cryptographic key; and trigger a process in the user device to store information contained in the digital object on the user device. Yet another embodiment is a system. The system includes a user device of a user configured to collect a user information and a product information from the user; transmit the user information and the product information to a server, the server configured to generate a digital object based on the user information and the product information, wherein the digital object comprises information for the user to utilize the service associated with the product; and transfer the digital object to the user device for utilizing the service associated with the product. In an embodiment, the service is an insurance service. In an embodiment, the system includes a plurality of layers, each layer secure for at least one provider of the service and a data center of the at least one provider.

In an embodiment, at least one layer includes product information for at least one product or one brand, the at least one brand comprising a plurality of related products, the at least one layer allowing users to download information and an application (app) for the at least one product or one brand, the app suitable for a computer of the user.

In an embodiment, the at least one layer includes product information for a plurality of products or brands of a merchant, wherein a brand comprises a plurality of related products, the at least one layer allowing users to download information and an application (app) for at least one product or brand of the merchant, the app suitable for a computer of the user. In an embodiment, the app is adapted for a user to organize products, brand apps and merchant apps. In an embodiment, the system is adapted to allow an agent of a first plurality of providers of the service access to the plurality of layers of the first plurality of providers of the service, and the system is adapted to allow the user of a second plurality of providers of the service access to the plurality of layers of the second plurality of providers of the service.

Another embodiment is an article comprising a secure digital object, the secure digital object containing product information and purchaser information received from a point of sale facility following the purchase of the product by the purchaser and containing service information for a service associated with the product; and a wrapper for the secure digital object, the wrapper providing security for the digital object and being adapted for delivery of the digital object to at least one of a device and an account of the purchaser and for management of access to the service by the purchaser using at least one of the device and the account. In an embodiment, the secure digital object comprises proof of ownership of the product and a proof of a right to access a warranty service associated with the product.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the methods and systems disclosed herein.

FIG. 1 illustrates a system for enabling a user to utilize a service associated with a product in accordance with an embodiment of the methods and systems disclosed herein.

FIG. 2 illustrates a digital object in accordance with an embodiment of the methods and systems disclosed herein.

FIG. 3 illustrates a system for enabling an interaction between a consumer application module of a user device and one or more server suites in accordance with an embodiment of the methods and systems disclosed herein.

FIG. 4 illustrates a cloud service system for enabling the user to utilize the service via a cloud interface in accordance with an embodiment of the methods and systems disclosed herein.

FIG. 5 illustrates a business-to-consumer (B2C) communication system for establishing a secure connection between a consumer and one or more servers in accordance with an embodiment of the methods and systems disclosed herein.

FIG. 6A is a flowchart of a method for enabling the user to utilize the service associated with the product in accordance with an embodiment of the methods and systems disclosed herein.

FIG. 6B illustrates a simplified relationship between an entity utilizing a digital object as part of its interactions and services provided to a consumer.

FIG. 6C depicts a digital object that is associated with media, data, and program snippets as part of warranty, insurance and other service offerings provided to a consumer.

FIG. 7 is a flowchart of the method for enabling the user to utilize the service associated with the product in accordance with another embodiment of the methods and systems disclosed herein.

FIG. 8 is a flowchart illustrating a method for utilizing one or more digital warranty services via a user application in accordance with an embodiment of the methods and systems disclosed herein.

FIG. 9 is a flowchart illustrating a method for utilizing an extended warranty service via a user application in accordance with an embodiment of the methods and systems disclosed herein.

FIG. 10 is a flowchart illustrating a method for utilizing an entitlement service via a user application in accordance with an embodiment of the methods and systems disclosed herein.

FIG. 11 is a flowchart illustrating a method for accessing an entitlement service history via a user application in accordance with an embodiment of the methods and systems disclosed herein.

FIG. 12 is a flowchart illustrating a method for accessing product support/manuals via a user application in accordance with an embodiment of the methods and systems disclosed herein.

FIG. 13 is a flowchart illustrating a method for locating deals via a user application in accordance with an embodiment of the methods and systems disclosed herein.

FIG. 14 is a flowchart illustrating a method for accessing a cloud sale service via a user application in accordance with an embodiment of the methods and systems disclosed herein.

FIG. 15 is a flowchart illustrating a method for transferring an ownership of a warranty via a user application in accordance with an embodiment of the methods and systems disclosed herein.

FIG. 16 is a flowchart illustrating a method for accessing an accessory cloud shop via a user application in accordance with an embodiment of the methods and systems disclosed herein.

FIG. 17A illustrates an architecture for enabling the user to utilize a plurality of services via a user device in accordance with an embodiment of the methods and systems disclosed herein

FIG. 17B depicts the Brand App Plug-in's compatibility with multiple platforms.

FIG. 17C is a flowchart depicting a process of customer authentication and use of crypto keys.

FIG. 17D is a flowchart depicting a process of key regeneration and browser access.

FIG. 17E depicts a simplified diagram of platform elements and their relationships to marketplaces.

FIG. 18 illustrates an architecture for a registration process that is driven by processes initiated by the manufacturer in accordance with an embodiment of the methods and systems disclosed herein.

FIG. 19 illustrates an architecture for a registration process that is driven by processes initiated by the platform in accordance with an embodiment of the methods and systems disclosed herein.

FIG. 20A illustrates various customer touch-points that aid product registration in accordance with an embodiment of the methods and systems disclosed herein.

FIG. 20B illustrates an integrated ecosystem in which the Brand App Server may operate.

FIG. 21 illustrates an ecosystem in accordance with an embodiment of the methods and systems disclosed herein.

FIG. 22 illustrates elements included in the Brand App and associated functionalities.

FIG. 23 depicts a simplified view of a product registration process within the Brand App.

FIG. 24 depicts a simplified view of a product selector process within the Brand App.

FIG. 25 depicts a simplified view of presenting product detail information to a user of the Brand App.

FIG. 26 illustrates the relationships among a plurality of entities and the cloud computing-based on-demand analytics.

FIG. 27 illustrates a flow diagram of a consumer service scheduling process.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the methods and systems disclosed herein.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art. The claims should be consulted to ascertain the true scope of the disclosure.

Before describing in detail embodiments that are in accordance with the methods and systems disclosed herein, it should be observed that the embodiments reside primarily in combinations of method steps and/or system components related to enabling a user to associate a service with a product in a way that makes it much more convenient and effective for the user to take advantage of the benefits of the service in connection with the product. Accordingly, the system components and method steps have been represented where appropriate by conventional symbols in the drawings, showing only those specific details that are pertinent to understanding the embodiments of the methods and systems disclosed herein so as not to obscure the disclosure with details that will be readily apparent to those of ordinary skill in the art having the benefit of the description herein.

Disclosed herein are methods and systems that enable a user to associate a service with a product and to utilize a service associated with a product. The methods and systems may include collecting user information and product information at the time of purchase of the product. The methods and systems may further include transferring the user information and the product information to a server. In addition, the methods and systems may include generating a digital object at the server, wherein the digital object comprises proof of ownership and the necessary information to enable the user to utilize the service associated with the product. Thereafter, the methods and systems may include transferring the digital object to a user device, wherein the digital object is stored thereon in order to enable the user to utilize the service associated with the product.

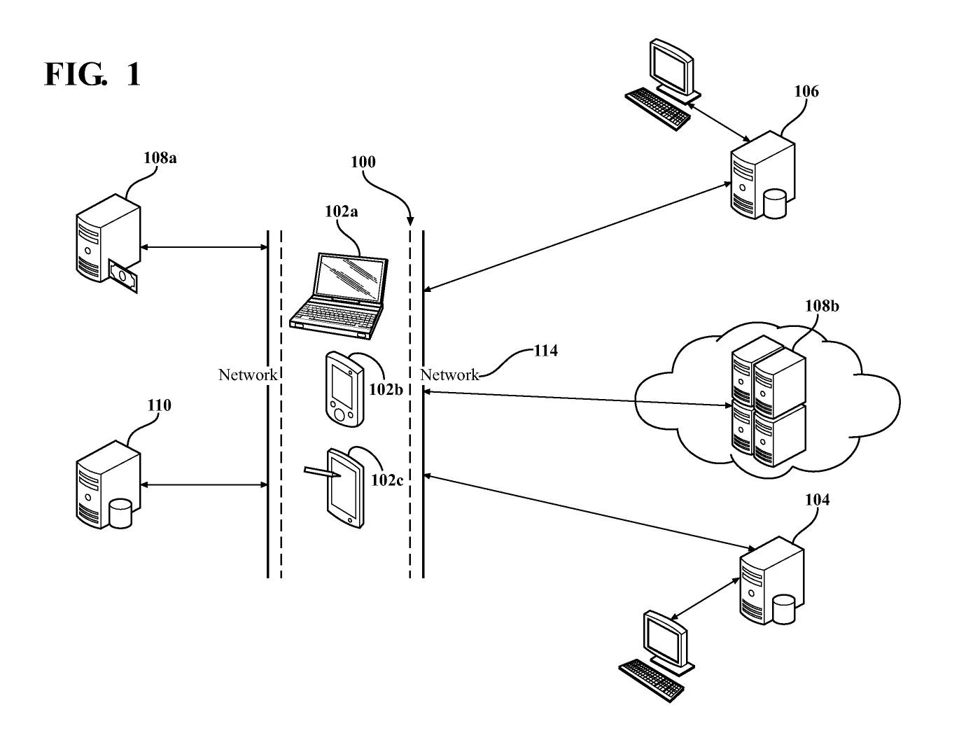

FIG. 1 illustrates a system 100 for enabling a user to utilize a service associated with a product in accordance with an embodiment of the methods and systems disclosed herein. The service associated with the product can be, but need not be limited to, a warranty service, an insurance service, an entitlement service, an upgrade service, a maintenance service, an update service, a retail service, a rebate service, a returns service, a recycling service, a transport service and a refurbishing service.

As illustrated, system 100 includes one or more user devices such as, but not limited to, a user device 102a, a user device 102b and a user device 102c and one or more servers such as, but not limited to, a manufacturer server 104, a merchant server 106, a cloud server 108a, a cloud server 108b and a third party service provider server 110.

The one or more user devices are devices such as, but not limited to, personal digital assistants, computers, laptops, smart phones and tablets. Further, each of the one or more user devices includes a user interface that enables the user to utilize the service associated with the product. In addition, each user device may be configured to facilitate the user device to utilize the service. For instance, the user device can be a personal computer such as user device 102a, including a software application that enables the user to utilize an entitlement service associated with a product. Taking another instance, the user device can be a mobile phone such as user device 102b, including a mobile application that enables the user to utilize a warranty service associated with a product.

The user device may be configured to send one or more of user information and product information associated with the product to one or more of the servers. The user information can include one or more of, but not limited to, a user name, address details, a user account detail, financial information, email address, and/or a telephone number of the user. In an embodiment, the user manually enters the user information and thereafter, the user information is sent from the user device to one or more of the one or more servers. In another embodiment, the user information which is already available on the user device is directly transferred to one or more of the server(s) when required via a network having various components, such as a wired or wireless network including, but not limited to Bluetooth®, Bluetooth Low Energy (BTLE)®, cellular (e.g., 3G, 4G or other generation cellular network), near field communication (NFC), wiFi, iBeacon™, internet, intranet, Local Area Network (LAN), Wireless Local Area Network (WLAN), Wireless Wide Area Network (WWAN), Wireless Metropolitan Area Network (WMAN), Wide Area Network (WAN) or other telecommunication networks and components readily known to the art.

The product information can include one or more of, but not limited to, a SKU, a product name, a brand name, a generic name, a model number, a serial number, a lot number, a batch number, a manufacturer date, a dealer's name, and a dealer's identifier number. The product information can be sent from the user device using methods such as, but not limited to, manually entering the product information and by scanning one or more identifiers associated with the product. The one or more identifiers can include identifiers such as, but not limited to, Quick Response (QR) codes, Universal Product Codes (UPC) codes and European Article Number (EAN) codes.

In accordance with an embodiment of the methods and systems disclosed herein, each of the one or more user devices may comprise a user interface module that is configured to generate a network accessible graphical user interface. The network accessible graphical user interface may enable the user view, store, enter, transmit and/or edit information associated with the product. For example, the user can view details associated with one or more products broadly classified into various categories such as, but not limited to, vehicles, appliances, electronic gadgets, personal products and house related products. Further, the user can view the product information such as, but not limited to, a product manual and a user manual via the graphical user interface. In addition, the network accessible graphical user interface can also allow the user to perform user account related activities such as, but not limited to, view, enter and/or edit information associated with the user account.

The one or more user devices may be connected to the one or more servers for enabling the user to utilize the service associated with the product. The connection can be established via a network 114 such as, but not limited to, cellular, internet, intranet, Local Area Network (LAN), Wireless Local Area Network (WLAN), Wireless Wide Area Network (WWAN), Wireless Metropolitan Area Network (WMAN), Wide Area Network (WAN) and telecommunication network.

The one or more user devices may be connected to the one or more servers via one or more point of sale terminals (not illustrated in FIG. 1). The one or more point of sale terminals can include one or more of, but not limited to, one or more cash registers/drawers, one or more bar code readers, manual entry equipment (e.g., keyboards), one or more display devices, one or more check processing equipment and one or more credit card processing equipment. Each of the one or more point of sale terminals may be configured to collect the user information and the product information at the time of purchase of the product. Further, each of the one or more point of sale terminals may be configured to collect the information by one or more of receiving a manual input corresponding to the user information and the product information, receiving the user information via a short range communication technology from the user device, and scanning an identifier associated with the product to obtain the product information. In addition, each of the one or more point of sale terminals is configured to send the user information and the product information to a server of the one or more servers.

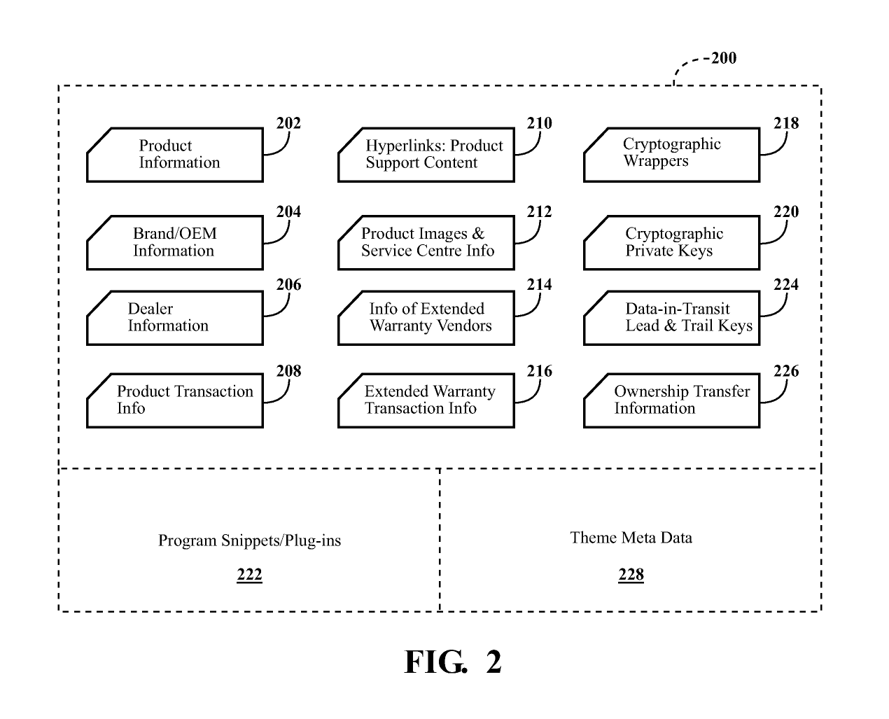

Each of the one or more servers may be configured to receive the user information and the product information associated with the product. In an embodiment, the user information and the product information are received at the server directly from the user device. In another embodiment, the user information and the product information may be received at the server from a point of sale terminal. Further, each of the one or more servers may be configured to generate a digital object (described in detail in conjunction with the description of FIG. 2) based on the user information and the product information received from the one or more point of sale terminals. Each of the one or more servers may also be configured to transfer the digital object to the one or more user devices in order to enable the user to utilize the service associated with the product. The one or more servers may be in a single location or in multiple locations. The one or more point of sale terminals may be in a single location or in multiple locations. A location may be a retail location, a geographic location or other appropriate location. A retail location may be a retail store location a check-out aisle in a retail location, and other appropriate location for retail sales. A geographic location may be a town or city, or a country. User information may be purchaser user information or recipient user information. In one example, a purchaser user may purchase a product, such as a mobile phone or household appliance, as a gift in a first retail location for a recipient user in a second retail location. If a purchaser user purchases a product in a first retail location as a gift for recipient user in a second retail location, a point of sale terminal in first retail location may send product information to a server and a point of sale terminal in second retail location may send user information to the server.

FIG. 2 illustrates a digital object 200 in accordance with an embodiment of the methods and systems disclosed herein. Digital object 200 can be, but need not be limited to, a Binary Large Object (BLOB) that can be encrypted and encapsulated in a digital security wrapper. Digital object 200 may be a secure digital object, encapsulated in a wrapper, protected by one or more cryptographic private and public key pairs 220, one or more data-in-transit lead and trail keys 224. The wrapper may be a digital security wrapper, one or more cryptographic wrappers, or both. Digital object 200 may be configured to include information that enables or allows the user to utilize the service associated with the product. The information in digital object 200 can include one or more of, but not limited to, a product information 202, a manufacturer information 204, a dealer information 206, a product transaction information 208, one or more hyperlinks for accessing one or more product manuals 210, one or more product images and service centre information 212, information of extended warranty vendors 214, an extended warranty transaction information 216, one or more cryptographic wrappers 218, one or more cryptographic private and public key pairs 220, one or more data-in transit lead and trail keys 224 and a product ownership transfer information 226. For example, the information in digital object 200 can enable the user to utilize a warranty service associated with the product. Accordingly, digital object 200 can include information such as warranty information, extended warranty service provider information, product ownership information and so forth. The digital object 200 may be read-only or read-write. In embodiments, the digital object 200 may be read only, permanent, and never overwritten. The digital object 200 may include program snippets and/or plug-ins 222, and theme metadata 228.

The digital object 200 may be a persistent data structure that is adapted to be stored in long term storage accessible by the user, such as on the user's device in a secure location, on a cloud storage facility dedicated to long term storage for the user, on a portion of an on premises network dedicated to the user, or the like. In embodiments the persistent data structure may be stored by an enterprise or institution, such as to maintain a long term record of the association of a product and the user for purposes of recognizing the user's entitlement to post-product services, information, or the like.

In accordance with various embodiments, digital object 200 can be used to provide the user with a digital evidence of ownership to claim entitlements. For instance, digital object 200 can be a digital warranty that can be transferred to the user during purchase. Accordingly, the digital warranty can serve as a replacement for a paper bill/invoice as a proof of ownership and the date of purchase (to fix the start date of warranty). A digital warranty as used herein may comprise, except where context indicates otherwise, a warranty, extended warranty, guarantee, extended maintenance contract, insurance (e.g., against loss, malfunction, defect, or other risk), or the like.

Digital object 200 can be also be configured to enable the user to utilize the service associated with the product. In order to enable the user to utilize the service associated with the product, digital object 200 can be configured to automatically unwrap when placed in a specially coded software container located at each of the one or more user devices. For example, digital object 200 may automatically unwrap information when placed in a mobile phone. The unwrapped data can be securely stored in a local storage of the one or more user devices. The unwrapped data can then be utilized to enable the user to utilize the service associated with the product. For example, the unwrapped data can include ownership information, warranty information such as, but not limited to, one or more warranty service providers, one or more third party extended service providers, and one or more warranty service centers, in order to utilize a warranty service associated with the product, as well as digital insurance information. The user may be the purchaser user, or the recipient user. In one example, if a purchaser user, such as a son or daughter, purchases a home appliance for an elderly or disabled parent, purchaser user could use the unwrapped data to have the home appliance serviced on behalf of the recipient user.

The unwrapped data may be unwrapped prior to the user having a need to enable the user to utilize the service associated with the product. If the unwrapped data is unwrapped prior to the user having a need to enable the user to utilize the service associated with the product, valuable time may be saved in emergency situations. An example of an emergency situation may be a potentially dangerous product malfunction. Potentially dangerous malfunctions may include a refrigerator, freezer, or climate control system not providing hot air or cold air, a stove leaking gas, a dishwasher leaking water, an electronic device not powering up in the “on” mode, a circuit-based device having a short circuit, or other malfunctions.

Each of the one or more servers includes one or more modules, each of which may be configured to enable the user to securely exchange data with the one or more servers. For example, a cloud based service module in one of cloud server 108a, and cloud server 108b enables the user to avail services related to one or more of, but not limited to, an extended warranty, a product accessory and a used product with an authenticated service record. Similarly, a service module in one of cloud server 108a and cloud server 108b can provide an online service or a user application in order to enable the user to exchange data with at least one of manufacturer server 104, merchant server 106 and third party service provider server 110 such as, but need not be limited to, a related insurance company, a re-insurance company and a wholesale warranty provider.

In order to enable the user to securely exchange data with the one or more servers, the user interface module of each of the one or more user devices may be configured to establish a secure connection with the one or more servers. The secure connection is established via the one or more modules of the one or more servers in response to the user initiating a service request via the graphical user interface of the user device. For example, the secure connection can be, but need not be limited to, a B2C communication channel that enables the user to communicate with the one or more modules of the one or more servers. The secure connection with the one or more servers can be established via at least one of HTTPS using a SSL certificate, HTTP connection with a secured keep-alive capabilities using SSL connection, AjaxCrypt using HTTPS-iframes, and/or “Light Safe Communication” with simple object access protocol (SOAP) authenticators.

The user interface module of each user device may be configured to access the user information and the product information via the one or more digital objects stored on the user device. Further, the user interface module can be configured to reprocess a transfer of the one or more digital objects from the manufacturer server 104 in response to a request initiated by the user via the user interface module. For example, the user interface module can send a transfer request to a warranty module in manufacturer server 104 to reprocess and send a digital warranty object when the user device has failed to receive the digital warranty object sent initially from manufacturer server 104.

The system described herein enables a user to utilize different services associated with a product. In a non-limiting example, a manufacturer server 104 may include a warranty entitlements module that is configured to receive an encrypted entitlement request from the user interface module in response to the user interface module determining a validity and applicability of a product warranty. Warranty entitlements module may receive and respond to an encrypted entitlement request from user interface module within a time window. For example, if a product is giving indications that it is damaged and further damage may occur to the product or the area surrounding the product unless product is repaired, user interface may allow a user to receive a timely indication that the required product repair is covered under warranty, providing the user, for example a service technician, to initiate the required repairs, thus preventing further damage to the product or the surrounding area. Time window may be the time between the user interface module determining a validity and applicability of a product warranty up to a time limit. Examples of a time limit are 1 minute, less than 1 second, less than 0.2 seconds, less than 0.1 seconds, 150 milliseconds, 250 milliseconds, 400 milliseconds, 1 millisecond, 1 nanosecond and 1 picosecond. The encrypted entitlement request may include one or more of a service type, a type of fix, a choice of data and time for rendering the service at a service center. Further, the warranty entitlements module may be configured to decrypt the entitlement request and send data to a product entitlement service for scheduling a service appointment. The information pertaining to the scheduling of the service appointment can also be transmitted to the user interface module by the warranty entitlements module. It should be apparent to one skilled in the art that the examples described herein are not limited to only warranty-related applications of the methods and systems disclosed. Various embodiments may be adapted to service other products, such as, but not limited to, digital insurance.

The user interface module can be configured to enable the user to view information associated with the service appointment via the user interface. For example, the user interface module allows the user to view and choose the service type, the type of fixes, select the date and time of service, out of available options, as to when the service can be provided at the service center or by a house call by a service technician. In another example, the user interface module allows the user to view information associated with a location of the service center such as, but not limited to, a location map of the service center, based on location information comprising latitude and longitude and driving directions to the service center.

The warranty entitlements module can also be configured to set up a follow-up reminder to the user in response to an initiation request by the service center. In a non-limiting example, the user interface module may be configured to establish a secure connection with an entitlements module located within the third party service provider server 110. Further, the user interface module may be configured to send a service history request via the user interface to the entitlements module. The service history request can include information such as, but not limited to, a part of the product information, a part of the user information, a start date and an end date for a period for which the service history is requested. The entitlements module can be configured to perform one or more of process the service history request, validate the user information and the product information, and send information associated with the service history to the user interface module, in response to receiving the service history request. The entitlements module can also be configured to update manufacturer server 104 with information associated with the service history request.

In embodiments, the user interface module may be configured to establish a secure connection with an extended warranty module located within the one or more servers in response to receiving a request from the user via the user interface. Further, the user interface module can be configured to send a request for the purchase of an extended warranty service, via the user interface, to the extended warranty module. The extended warranty module can be configured to transmit information associated with the extended warranty service to the user interface module for display, via the user interface, in response to receiving the request. The information associated with the warranty service can include one or more of a list of available warranty service providers, an information pertaining to an extended warranty in offer, a warranty entitlement, a price associated with a warranty and a warranty offer. The user can input the user information and the product information via the user interface based on a selection of the information associated with the warranty service. The user interface module can accordingly transfer the user input to the extended warranty module. The extended warranty module can then process form data associated with the extended warranty service, validate the user information and the product information and send payment information associated with the extended warranty service to the user interface module. Once the user makes a secure payment during a transaction for extending the warranty via the user interface, the extended warranty module can process the transaction and push a digital warranty object associated with the product and the user to one or more of the one or more user devices.

The extended warranty module can also update information associated with the transaction in one or more databases of one or more stakeholders. The one or more stakeholders can be, but need not be limited to, a manufacturer, a warranty service provider, an entitlement service provider and an insurance company.

In case delivery of the digital warranty object is delayed from the extended warranty module, a warranty synchronization request can be initiated via the user interface module of each of the one or more user devices. In response to the warranty synchronization request, a module in cloud servers 108a, 108b may re-initiate delivery of the digital warranty object to the user interface module.

In embodiments, the user interface module can be configured to establish a secure connection with a digital warranty module located within the one or more servers in response to receiving a request from the user via the user interface. The digital warranty module can be configured to receive a warranty transfer request from the user via the user interface. The transfer request can include information such as, but not limited to, a part of the user information, a part of the product information and an information associated with a new user for the warranty transfer. The digital warranty module can then process the information associated with the warranty transfer request and send a confirmation message to the user interface indicating that the warranty transfer has been initiated. The digital warranty module can also be configured to deliver a digital warranty object associated with the warranty transfer request to a user device of the new user to complete the warranty transfer.

In embodiments, the user interface module can be configured to establish a secure connection with a product reverse logistics service module located within the ‘distributed network of cloud servers’ 108a, 108b. Accordingly, the user interface module can be configured to send a product reverse logistics process request containing a part of the product information via the user interface to the product reverse logistics module. The product reverse logistics module can be configured to enable the user to connect to at least one of a call center service, a depot repair service, an onsite repair service, a transport service, a recycling service, a refurbishing service, a spare parts service and a returns service in response to receiving the product reverse logistics process request. Product reverse logistics module may enable the user to connect to at least one of a call center service, a depot repair service, an onsite repair service, a transport service, a recycling service, a refurbishing service, a spare parts service and a returns service in response to receiving the product reverse logistics process request within a time window. Time window may be the time between when product reverse logistics module receives a product reverse logistics process request up to a time limit. For example, if a user detects an indication that the product may be damaged, user may communicate such indication to a call center and call center, based on the indication, may automatically initiate product shutdown procedures, possibly preventing damage to the product, area surrounding the product, or the user. Examples of time limits include 1 minute, less than 1 second, less than 0.2 seconds, less than 0.1 seconds, 150 milliseconds, 250 milliseconds, 400 milliseconds, 1 millisecond, 1 nanosecond and 1 picosecond.

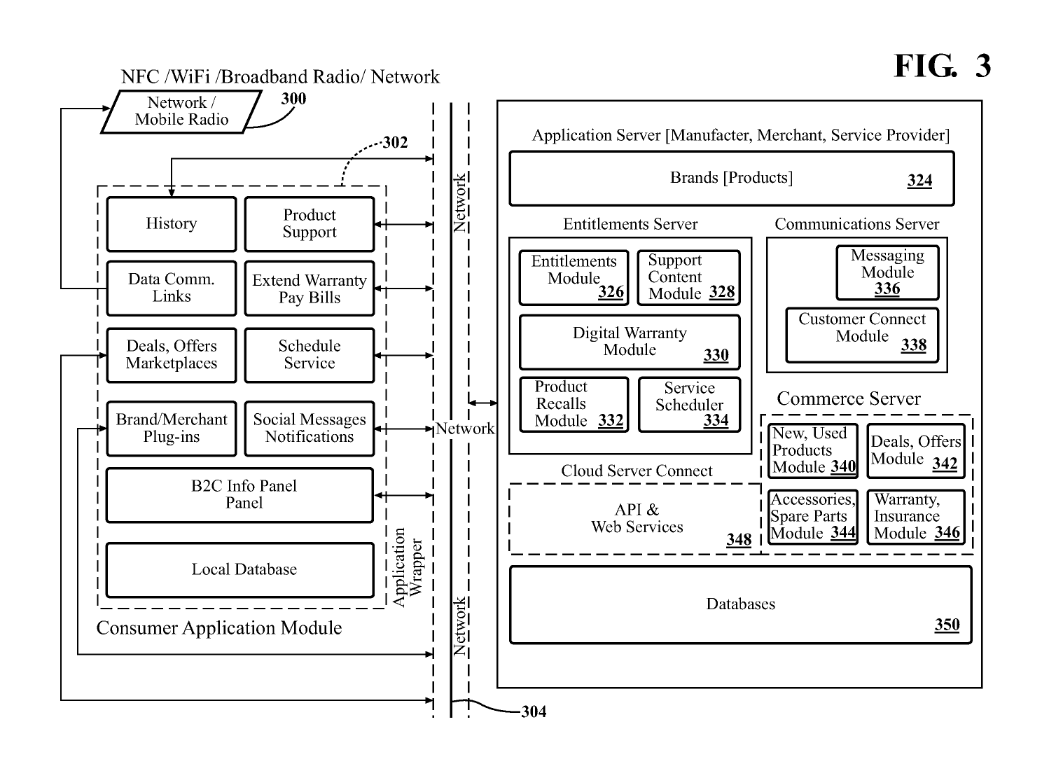

FIG. 3 illustrates a system for enabling an interaction between a consumer application module 302 of a user device and one or more server suites in accordance with an embodiment of the methods and systems disclosed herein.

In embodiments, each of the one or more server suites may include one or more modules to enable the interaction between the consumer application module 302 and the one or more server suites in the network. The consumer application module 302 in the user device includes an application wrapper. The application wrapper provides a secured space in the user device for the user application to run and execute while ensuring data security and integrity. Local database 320 on the consumer application module 302 stores the information present within the application wrapper and can be accessed by the user via the user device interface as and when the information is required. As illustrated, the one or more server suites include a product server, an entitlements server, a communications server, a commerce server, cloud server interconnect and various other databases. The product server includes various brands of products such as brands 324. The entitlements server includes an entitlements module 326, a support content module 328, a digital warranty module 330, a product recalls module 332 and a service scheduler 334. The communications server includes a messaging module 336 and a customer connect module 338. The commerce server includes a used products module 340, a discount offers module 342, an accessory sale module 344 and an extended warranty module 346. In embodiments, cloud computing server connectivity may include API and web services 348.

In embodiments, the consumer application module 302 may interact with one or more server suites. In embodiments, the methods and systems disclosed herein may facilitate providing details of service history. The consumer application module 302, responsive to a network or mobile radio request of the user 300, may establish a secured connection with entitlements module 326 located with a warranty service provider. The consumer application module 302 may send a history information request, constituting a part of the product information and information pertaining to a start and end date for which a service history is requested. Entitlements module 326 may process the request and validate the user information and the product information. Entitlements module 326 may process the request and validate the user information and the product information in a time window. Time window may be the time between entitlements module 326 receiving history information request up to a time limit. For example, users, such as law enforcement officials, may use the history information at a cross-border package processing and clearance center, where it is desirable to minimize delays in processing package clearances to allow the packages to cross a border, to confirm that a product has not been stolen. Examples of time limits include 1 minute, less than 1 second, less than 0.2 seconds, less than 0.1 seconds, 150 milliseconds, 250 milliseconds, 400 milliseconds, 1 millisecond, 1 nanosecond and 1 picosecond. Entitlements module 326 then may send details of the service history to the consumer application module 302. Thereafter, entitlements module 326 may send the details of the service history request to update a database of the warranty service module of manufacturer.

In embodiments, the methods and systems disclosed herein may facilitate providing product manuals. The consumer application module 302, responsive to a request of the user, may establish a secured connection with support content module 328 located with the warranty service provider. A consumer information module retrieves a list of product documents from manufacturer's database 350 and displays the list of product documents for the user to view and select. The consumer application module 302 then retrieves product support content using one or more internet hyperlinks from the manufacturer's databases, responsive to the user choosing a product manual.

In embodiments, the methods and systems disclosed herein may facilitate the location of product discounts and/or the location or execution of product rebates. In embodiments, the consumer application module 302, responsive to the request of the user, may establish a secured connection with discount and rebate offers module 342 provided via a cloud service. Discount offers module 342 in the cloud service may be continuously updated with new discount and rebate offers, such as from manufacturers, multi-brand chain stores and/or merchants, via IT infrastructure of those parties or via the cloud. The consumer application module 302 may be configured to initiate a discount or rebate search request constituting a part of the product information, a geographical location and an offer coupon information. Responsive to the discount or rebate search request, the discount offers module retrieves, as search results, one or more offers that match with the discount or rebate search request and sends the one or more products that are under offer along with discount information to the consumer application module 302. The consumer application module 302 receives the search results, sorts the information and presents the one or more offers for the user to view in the consumer application module 302.

In embodiments, the methods and systems disclosed herein may facilitate the cloud sale of used products. The consumer application module 302, responsive to the request of the consumer, may establish a secured connection with used products module 340 located with a cloud service. The consumer application module 302 sends a part of the product information to initiate the search for used products available on sale over a distributed network of cloud servers that match the received product information. Used products module 340 retrieves primary search result information and sends the information to the consumer application module 302. The consumer application module 302 receives the primary search result information and presents the information for the user to view in the consumer application module 302.

In embodiments, the consumer application module 302 may send a request for detailed information of the product-on-sale to the used products module, responsive to the user selecting a used product for more details. The consumer application module 302 then sends a request to initiate a sale process for the selected used product, responsive to the user committing to purchase the used product and process the payment transaction. The used products module sends a notification to the user indicating the successful completion of the sale and initiates the post purchase delivery process of the product to facilitate the delivery of the product to the user.

In embodiments, the methods and systems disclosed herein may facilitate a product accessories shop. The consumer application module 302, responsive to a request of the user, may establish a secured connection with accessory sale module 344 located within the cloud service. The consumer application module 302 sends a part of the product information to initiate a search for accessories available that may match the received product information. Accessory sale module 344 retrieves primary search result information and sends the primary search result information to the consumer application module 302. The consumer application module 302 receives the primary search result information and presents the information for the consumer to view in the consumer application module. The consumer application module 302 sends a request for detailed information of the accessory to the accessory sale module, responsive to the consumer selecting an accessory to purchase.

In embodiments, the cloud service may forward the request to initiate the sale process, along with the product and consumer information, to a commerce module of the digital warranty system of the product manufacturer or the merchant of the accessory. The commerce module initiates the sale process for the selected accessory, responsive to the user committing to purchase, and interactively completes the process of the consumer completing the payment transaction. The commerce module informs accessory sale module 344 of the completion of the sale transaction. Accessory sale module 344 sends a notification to the user intimating the successful completion of the sale and initiates a post purchase delivery process of the product until the product is delivered to the user in coordination with the product manufacturer or the merchant of the accessory.

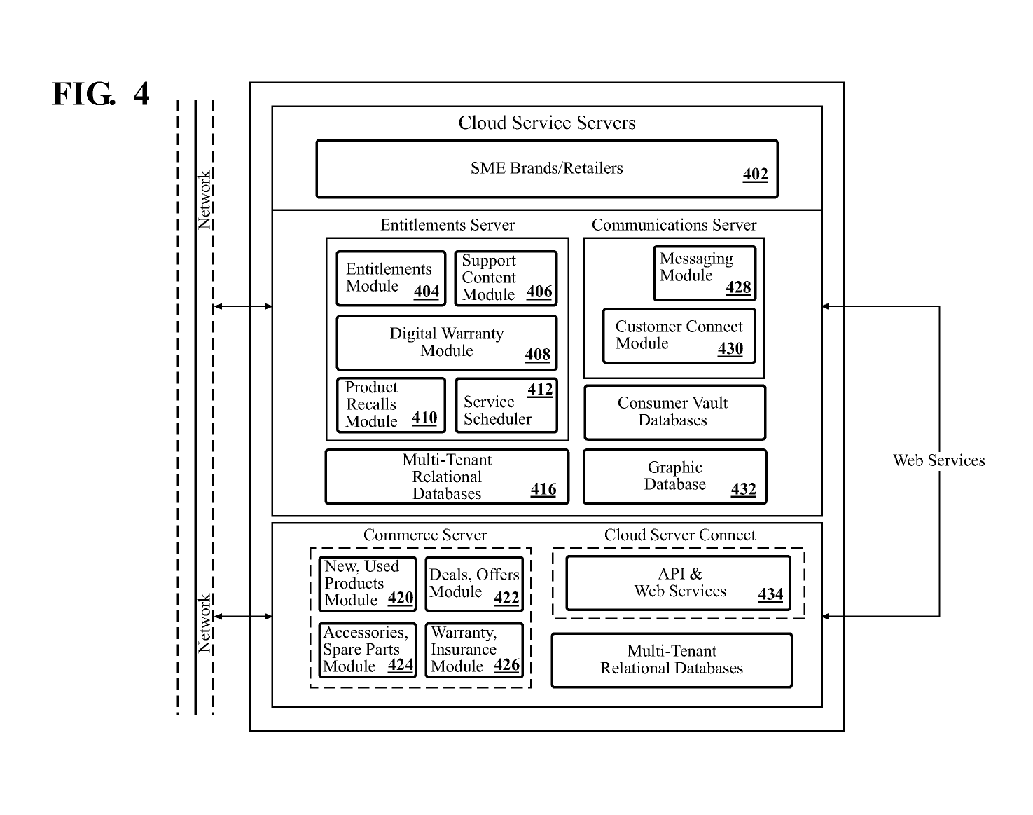

FIG. 4 illustrates a cloud service system for enabling the user to utilize the service via a cloud interface in accordance with an embodiment of the methods and systems disclosed herein. The functionality of the server suites of the cloud service system may be similar to that of the server suites described in FIG. 3 above. The cloud service system may include servers pertaining to brands and retailers 402, entitlements servers that include an entitlements module 404, a support content module 406, digital warranty module 408, product recalls module 410, a service scheduler 412, and/or multi-tenant rational databases 416. A communications server may include a messaging module 428, a customer connect module 430, customer vault databases and graphic databases 432. A commerce server may be provided that includes a new and used products module 420, a deals and offers module 422, an accessories and spare parts module 424, and a warranty and insurance module 426. An API and additional web services module 434 may also be provided.

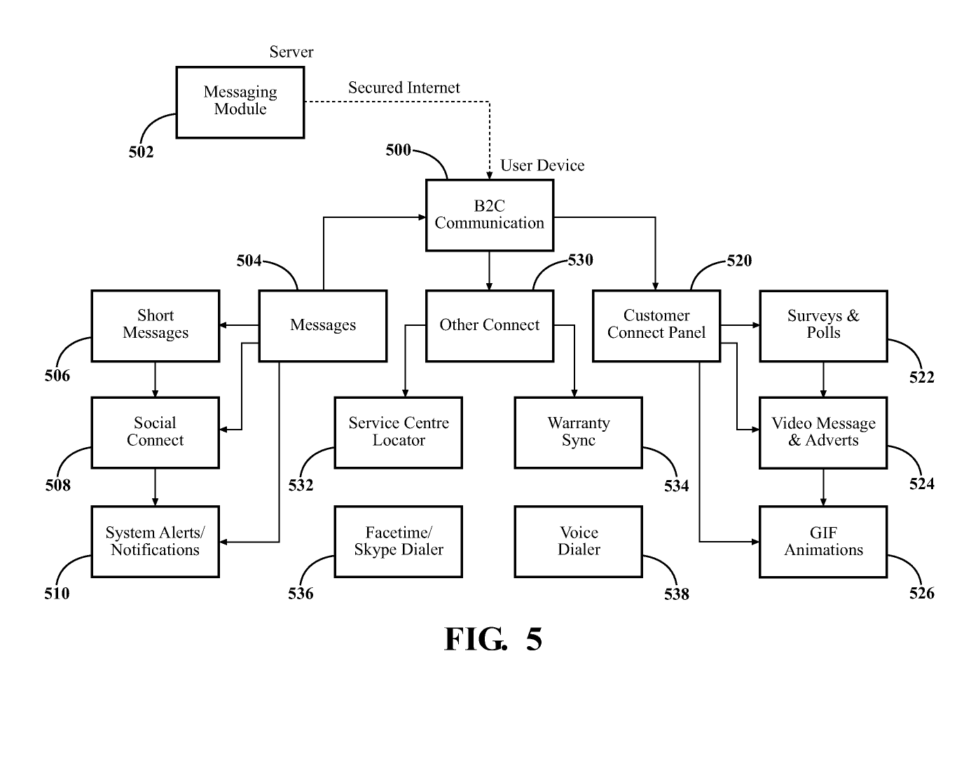

FIG. 5 illustrates a business-to-consumer (B2C) communication 500 system for establishing a secure connection between a consumer and one or more servers in accordance with an embodiment of the methods and systems disclosed herein. In embodiments, a consumer connect module, responsive to a paid request from at least one of the one or more servers, can establish the secure connection with a consumer panel module within the consumer application module. The one or more servers can include at least one of a manufacturer server, a multibrand dealership chain, a third party service provider and a merchant server. The consumer connect module then can send a secured media BLOB to the consumer connect panel. A module in the consumer connect panel is configured to automatically unwrap the secured media BLOB and process contents present in the secured media BLOB for display in the consumer connect panel.

Alternatively, the secure connection can also be established via a short messaging service. The messaging module 502 in the server, responsive to a request of the user, can establish messaging 504 for a secure connection for receiving a short message 506. The short message is a two way communication between the consumer and the server, wherein the server can be at least one of a manufacturer server, a multi brand dealership chain, a third party service provider and a merchant server. The consumer can also socially communicate 508 with other consumers for exchanging views, experience and advice, as well as receive system alerts and notifications 510 using the short messaging module. The consumer may make use of the other connect module 530 to locate the nearest service location 532 and synchronize their warranties 534. The customer connect panel 520 may allow for the consumer to participate in surveys and polls 522, view video messages and advertisements 524 as well as GIF animations 526. In embodiments, the B2C communication 500 may also be associated with communications capabilities, including but not limited to voice and video streaming technologies such as Facetime and Skype 536, and/or dial-based voice communications 538.

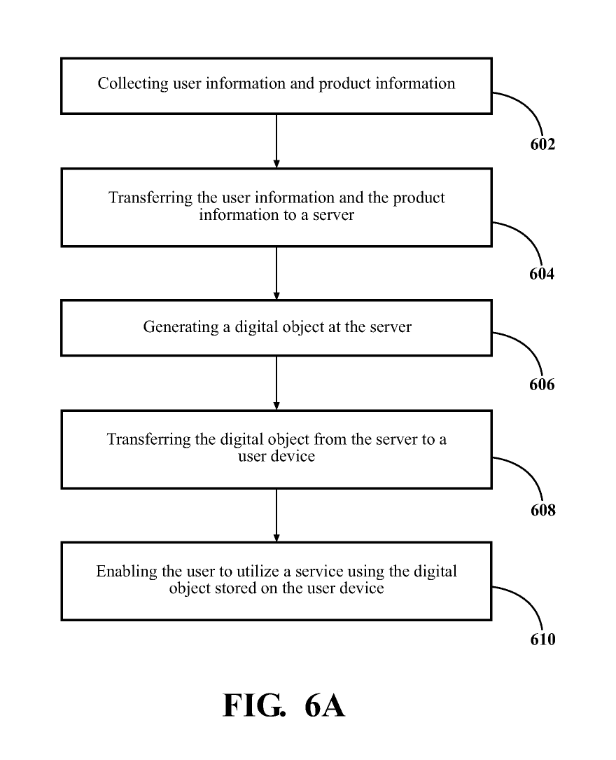

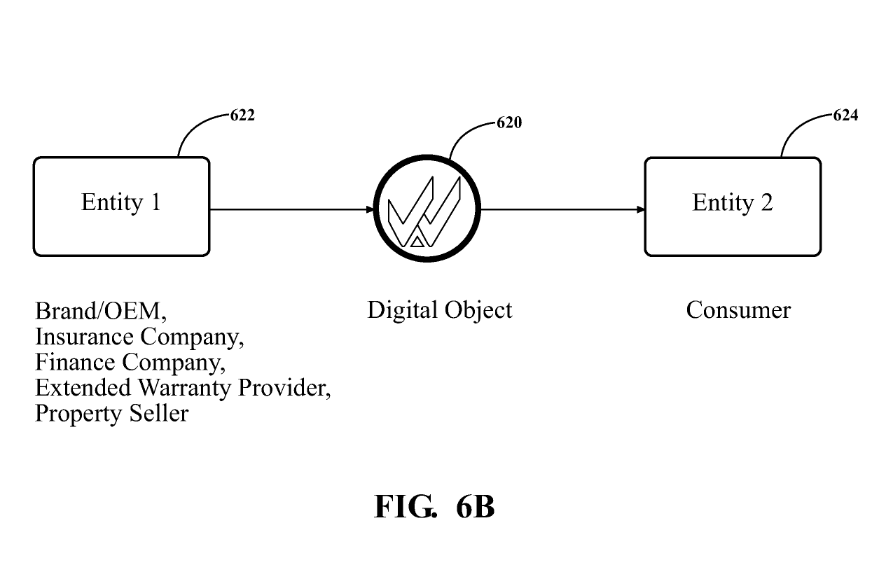

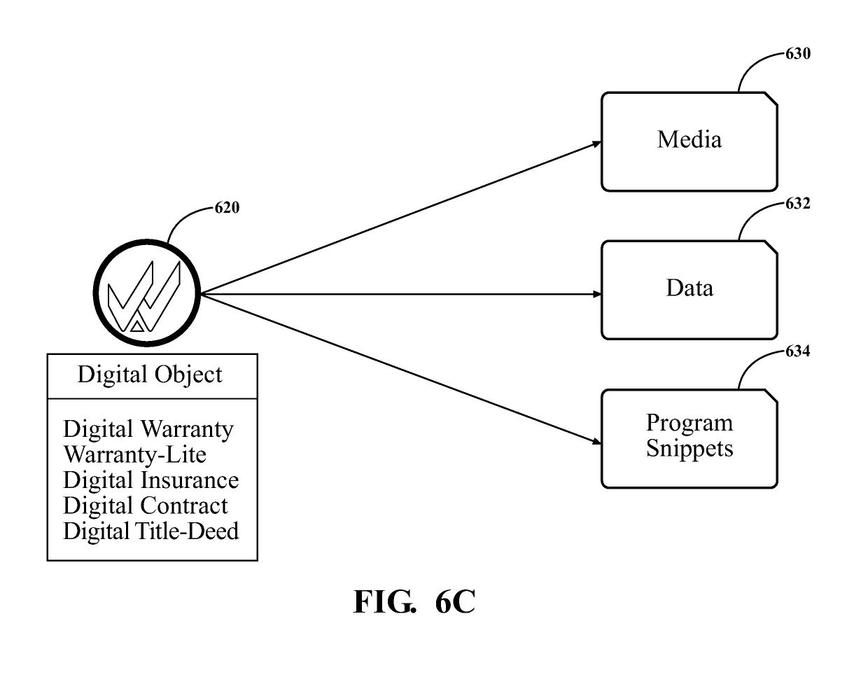

FIG. 6A is a flowchart of a method for enabling the user to utilize the service associated with the product in accordance with an embodiment of the methods and systems disclosed herein.

At step 602, a user information and a product information are collected from the user. The user information and the product information can be collected when the user buys the product from a merchant. Alternately, the user information and the product information can be provided by the user after purchasing the product from the merchant. At step 604, user and product information may be transferred to a server. At step 606, a digital object may be generated at the server. At step 608, the digital object may be transferred from the server to a user device. At step 610, the user may now able to utilize a service using the digital object stored on the user device. FIG. 6B depicts how an entity 622, such as an insurance company, finance company, extended warranty provider, property seller, or some other entity may use a digital object 620, as described herein, as an intermediary in the entity's relationship and interactions with a second entity 624, such as a consumer. FIG. 6C shows the relationship that a digital object 620, such as that containing a digital warranty, insurance, contract, deed or some other type of information, may have with other facilities, including but not limited to media 630, data 632, and program snippets 634.

In one embodiment, the user information and the product information are collected from a user device such as, but not limited, user device 102a, user device 102b and user device 102c. Further, the user information and the product information can be collected by triggering a request to the user to manually enter the user information and the product information. The request to the user to manually enter the user information may be triggered within a time window. Time window may be the time between when the user buys the product from a merchant up to a time limit. For example, user may be prompted with an option to enter user information immediately upon confirmation that the transaction has been completed and if user does not enter user information immediately upon confirmation that the transaction has been completed, transaction concludes and user is sent an email reminder to provide user information at a later time. Examples of time limits include 1 minute, less than 1 second, less than 0.2 seconds, less than 0.1 seconds, 150 milliseconds, 250 milliseconds, 400 milliseconds, 1 millisecond, 1 nanosecond and 1 picosecond. Alternately, the user information already present on or associated with the user device can be utilized and the product information can be collected either by scanning an identifier associated with the product or by triggering a request to the user to manually enter the product information. In another embodiment, the user information and the product information are collected from a point of sale terminal. In accordance with the embodiment, the user information and the product information can be provided via a manual input at the point of sale terminal. Alternately, the user information can be sent from the user device to the point of sale terminal via a short range communication technology, and the product information can be collected at the point of sale terminal either based on a manual input or by scanning an identifier associated with the product at the point of sale terminal. User information may be received by the point of sale terminal via short range communication technology within a time window. Time window may be the time between an identifier associated with a product being scanned up to a time limit. For example, a manufacturer may wish to incentive a purchaser of a product of a manufacturer to register a purchase. To incentivize the purchaser to register a purchase, manufacturer may offer a promotional item, to be given to the purchaser by the merchant at the time of purchase, if the purchaser registers the purchase before the purchaser leaves the purchase counter after the purchase has been completed. Examples of time limits include 1 minute, less than 1 second, less than 0.2 seconds, less than 0.1 seconds, 150 milliseconds, 250 milliseconds, 400 milliseconds, 1 millisecond, 1 nanosecond and 1 picosecond.

At step 604, the user information and the product information collected at step 602, are transferred to a server such as manufacturer server 104. The user information and the product information can be transferred via the user device. Thus, in one embodiment, the user information and the product information is transferred from the user device by establishing a secure connection between the user device and the server. In accordance with the embodiment, the user can utilize a bill/invoice for providing the product information. Further, the bill/invoice can be used as a confirmation of the payment for the product. Alternately, the user information and the product information can be transferred via the point of sale terminal. Accordingly, in another embodiment, the user information and the product information is transferred from the point of sale terminal to the server by establishing a secure connection between the point of sale terminal and the server.

In response to receiving the user information and the product information, the server may generate a digital object at 606, in order to the enable the user to utilize the service associated with the product. The digital object can also be generated as a digital evidence of ownership for the user to enable the user to claim entitlements. Further, the product information can then be associated with a user account on manufacturer server 104 based on the received user information. Alternately, if there is no user account for the user, the user account can be created on the server based on the received user information prior to associating the product with the user account.

In embodiments, step 606 may optionally involve encapsulating the digital object in a secured digital wrapper. Further, step 606 can also involve validating the user information against existing user account information, creating a new user account for a new user, validating loyalty information, validating sale invoice with information received from the merchant/retailer server and the product information prior to generating the digital object.

Thereafter, at step 608, the digital object is transferred from the server to the user device. By transferring the digital object to the user, the manufacturer/service provider can provide a digital evidence of ownership to the user. This digital evidence can be used by the user to claim entitlements. Step 608 can further include automatically unwrapping the digital object and storing the information present in the digital object on the user device. Step 608 can also include synchronizing the new information stored on the user device with a user account of the user, wherein the user account can be hosted on a cloud.

Thereafter, at step 610, the method includes enabling the user to utilize the service associated with the product using information stored in the user device. In an embodiment, step 610 may include enabling the user to utilize a warranty service associated with the product. This involves transferring a digital warranty for the product to the user in response to purchase of the product by the user. The warranty service can enable the user to view warranty information associated with the product. Further, the warranty service can enable the user to transfer the warranty associated with the product to another user by transferring the digital object the other user. Accordingly, step 610 can include updating the databases at the servers of the concerned stakeholders associated with the product in response to transferring the warranty to the other user. In one embodiment, the databases at the servers are synchronously or asynchronously updated, depending on the network traffic conditions, in response to transferring the warranty. The warranty service can also enable the user to purchase one or more of an extended warranty, an additional entitlement from a service provider and connect with a product reverse logistics process. Step 610 can also include updating the digital object with information associated with the purchase of one or more of the extended warranty and the additional entitlement in response to purchasing one or more of the extended warranty and the additional entitlement service.

The digital object may enable the user to receive information related to the service associated with the product. Accordingly, the method can optionally include pushing of information from the server or a service provider to the user device. The method can further include updating the digital object in response to receiving the information from the server or the service provider.

The digital object may enable the product to receive information related to the service associated with the product. In embodiments, the product may receive information related to the service associated with the product and execute the service associated with the product. The product may execute the service associated with the product with user intervention or without user intervention. A user may have pre-authorized services to execute associated with the product. Pre-authorized services to execute associated with the product may include routine and emergency services. Routine services may include routine maintenance services, routine cleaning services and routine check-up services. For example, an automobile product may detect that one of the cylinders of the automobile may be accumulating a level of residue that may impair the functioning of the cylinder. The automobile product may query the digital object to determine whether a service to initiate the cleaning of the cylinder is a pre-authorized service. If a service to initiate the cleaning of the cylinder is a pre-authorized service, the automobile product may initiate the cleaning of the cylinder, without requiring user interaction. Thus, a product may, based on storage of and operation on a digital object (optionally with a secure digital wrapper), undergo a physical transformation, such as from a pre-service (possibly defective or out-of-date) state to a serviced state, wherein defects have been corrected via an initiated service, the product has been brought up to date, or the like. Such products may include hardware, electrical, software, middleware and other components that are capable of self-service operation, whether using local components or by retrieving and executing downloadable components from remote locations. Examples include automotive products, appliances, computer hardware, consumer electronics devices, and many others.

Emergency services may include emergency shut-down services, emergency restart services and emergency notification services. For example, a user may forget to turn off a gas burner on a stove when the user leaves the home where the stove is located. The stove may detect that a gas burner has been left on and the user has left the home where the stove is located. The stove may then query the digital object for instructions to send a message to the user of the mobile device suggesting that the gas burner be turned off, that another person in the home where the stove is located is notified that the gas burner has been left on. Similar situations with other appliances may also apply.

Services associated with a product may be executed based on parameters related to the product. Parameters related to the product may include a hardware address, a geographical address, or other address. A hardware address may be an embedded hardware address, such as a media access control (MAC) address, and Internet Protocol (IP) address, or other suitable, useful address. A geographical location may be an authorized installation location or an unauthorized installation location. An authorized installation location may be a location authorized by the purchaser user, a recipient user, or other interested party. An unauthorized installation location may be a location deemed to be unsafe for installation of the product, a location indicating that the product may have been stolen, or other unauthorized location.

In an embodiment, the method may utilize a user device application that enables the user to manage the digital warranty service for a list of products purchased by the user. The user can view and select at least one product from the list of products in order to manage the warranty service for the at least one product. After selecting the at least one product, the user can view, edit and update information associated with the product via the user application. For example, the user can view at least one of a product manual and a mail associated with the warranty of the product. The user application also allows the user to perform at least one of locate a deal, locate a cloud sale service, purchase an extended warranty, synchronize a new warranty, schedule a warranty service, view service history associated with a warranty and view a product on sale information. The product on sale information can include, but need not be limited to, a brand name of the product, the product generic name, the product name, the model number, product warranty expiry information, product warranty expiry date, history of warranty entitlements services availed, major breakdowns, minor and major accident, date of manufacture of the product, number of past owners, certified current condition, purchase price of a new product and an advertised offer price. In addition, the product warranty expiry can be notified to the user in order to enable the user to purchase an extended warranty at the right time. Further, the warranty service can also enable the user to receive at least one of promotional product discount information, a rebate, and a bundle offer from manufacturer server 104.

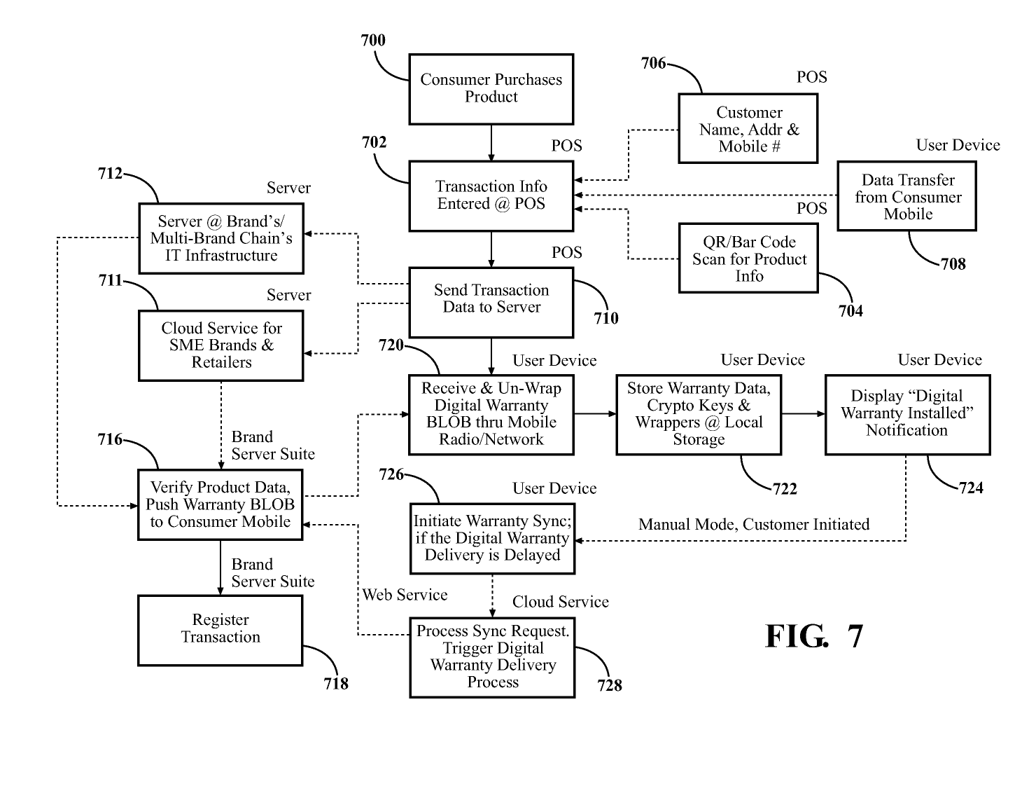

FIG. 7 is a flowchart of the method for enabling or allowing the user to utilize the service associated with the product in accordance with another embodiment of the methods and systems disclosed herein. In embodiments, the consumer may purchase a product 700, which involves entering transaction information at a point of sale terminal 702. The transaction information includes product data 704 consumer/purchaser data 706, and data transferred from the consumer's device 708. The transaction information is then sent to a merchant or brand's server suite 710. The merchant or brand's server suite includes at least one of a brand's/multibrand's chain IT infrastructure 712 and a cloud service for small and medium enterprise (SME) brands and retailers 711. At the brand's server suite, the product data is verified and in response to the verification, a digital warranty BLOB is pushed to the user device 716. The transaction information is then registered at the brand's server suite 718. At the user device, the user application receives and unwraps the digital warranty BLOB through a mobile radio/network 720. The user application then stores warranty data, one or more cryptographic keys and wrappers in a local storage of the user device 722. Thereafter, the user application sends a notification to the user device that the digital warranty BLOB has been installed in the user device 724. The user application may send a notification to the user device that the digital warranty BLOB has been installed in the user device in a time window. Time window may be the time between transaction information being entered at a point of sale terminal up to a time limit. For example, as a condition to offering a product discount to a user, a brand may require a user to register a product immediately upon purchase of the product, in order for the user to be provided with the discount. Brand's server suite may confirm that user has registered a product immediately upon purchase of the product by confirming that the digital warranty BLOB has been installed in the user device within a time window. Examples of time limits include 1 minute, less than 1 second, less than 0.2 seconds, less than 0.1 seconds, 150 milliseconds, 250 milliseconds, 400 milliseconds, 1 millisecond, 1 nanosecond and 1 picosecond. In some cases, the user application initiates a warranty sync request to a cloud service, if delivery of the digital warranty BLOB to the user device is delayed 726. The cloud services processes the warranty sync request and triggers the delivery process of the digital warranty BLOB to the user device 728.

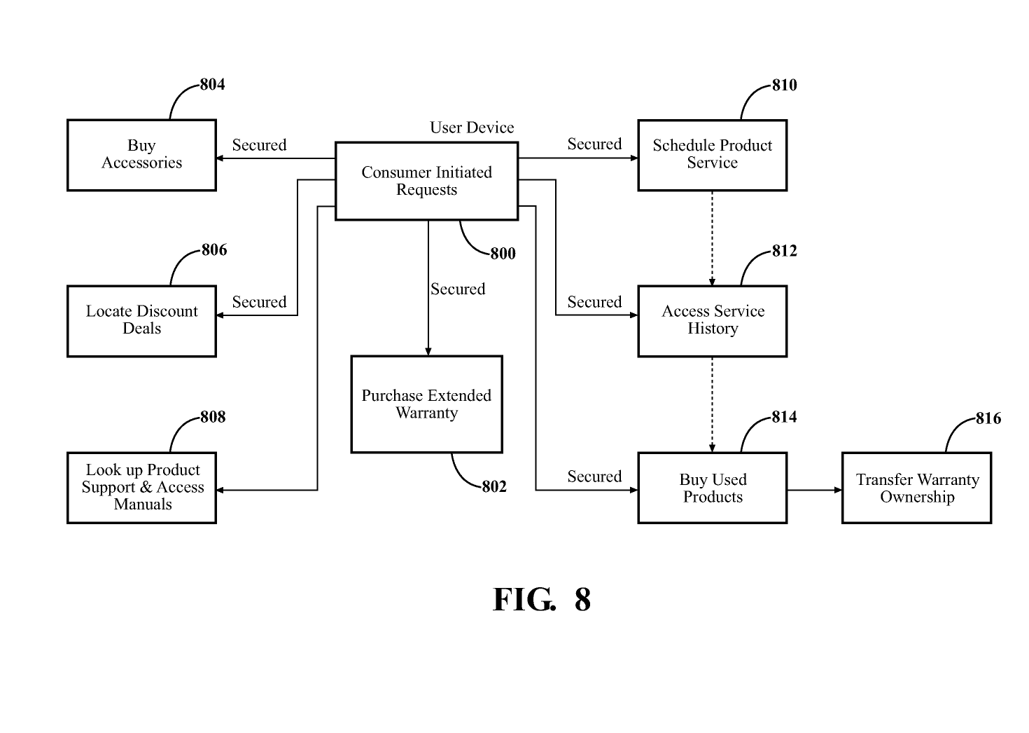

FIG. 8 depicts a flowchart illustrating a method for utilizing one or more digital warranty services via a user application in accordance with an embodiment of the methods and systems disclosed herein. In accordance with an embodiment, the user application processes consumer initiated requests 800 to buy accessories 804, locate discount deals 806, look up product support and access manuals 808, purchase extended warranty 802, schedule product service 810, access service history 812, buy used products 814 and transfer a warranty ownership 816.

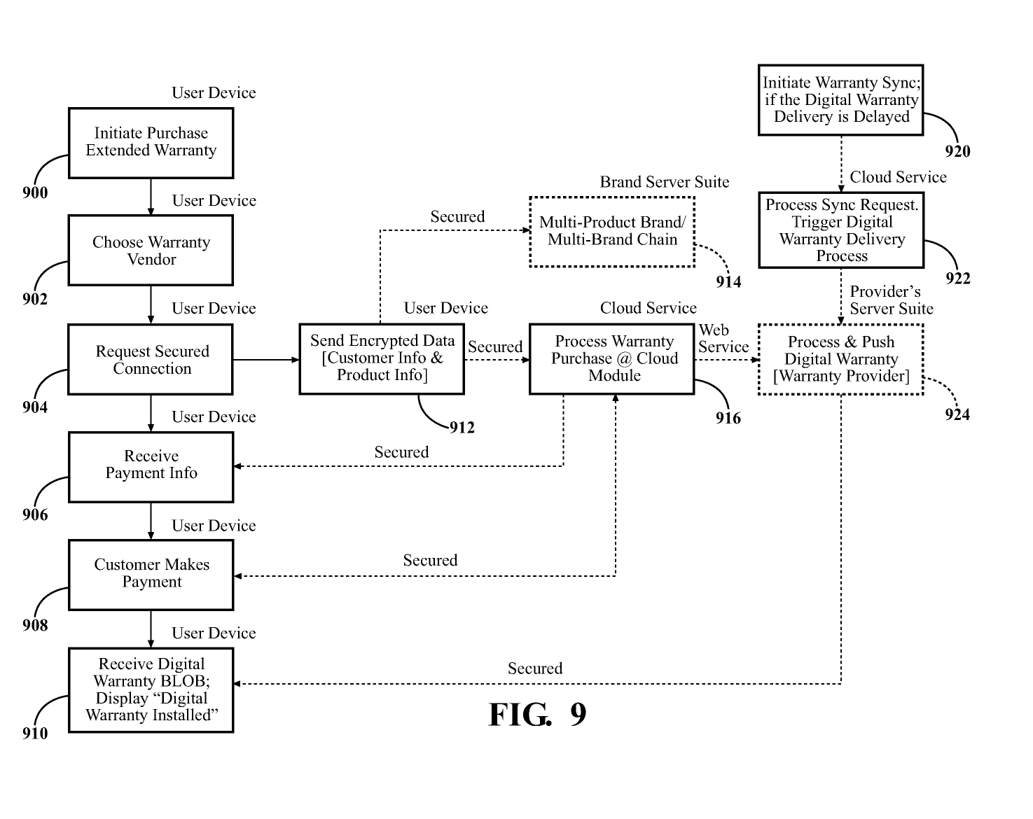

FIG. 9 depicts a flowchart illustrating a method for utilizing an extended warranty service via a user application in accordance with an embodiment of the methods and systems disclosed herein. In embodiment, the consumer may initiate a request to purchase an extended warranty service via the user application 900. In response to the request, the user application then enables the consumer to choose a warranty vendor 902 in response to the initiation of the request. Once the consumer chooses a warranty vendor, the user application requests a secured connection to a server 904, which includes at least one of the brand's server suite 914 and the cloud service. The user application then sends the product information and the consumer information as encrypted data to the server 912. Once the consumer makes a secure payment 908 during a transaction for purchasing the warranty, the user application sends the transaction information to the server. The server then processes the transaction and pushes a digital warranty BLOB to the user device 924. Once the user device has received the warranty BLOB, it displays a message stating “Digital Warranty Installed” 910. The application may further facilitate the receipt of payment information 906, processing warranty purchase information 916, and syncing and delivering warranty information 920 922.

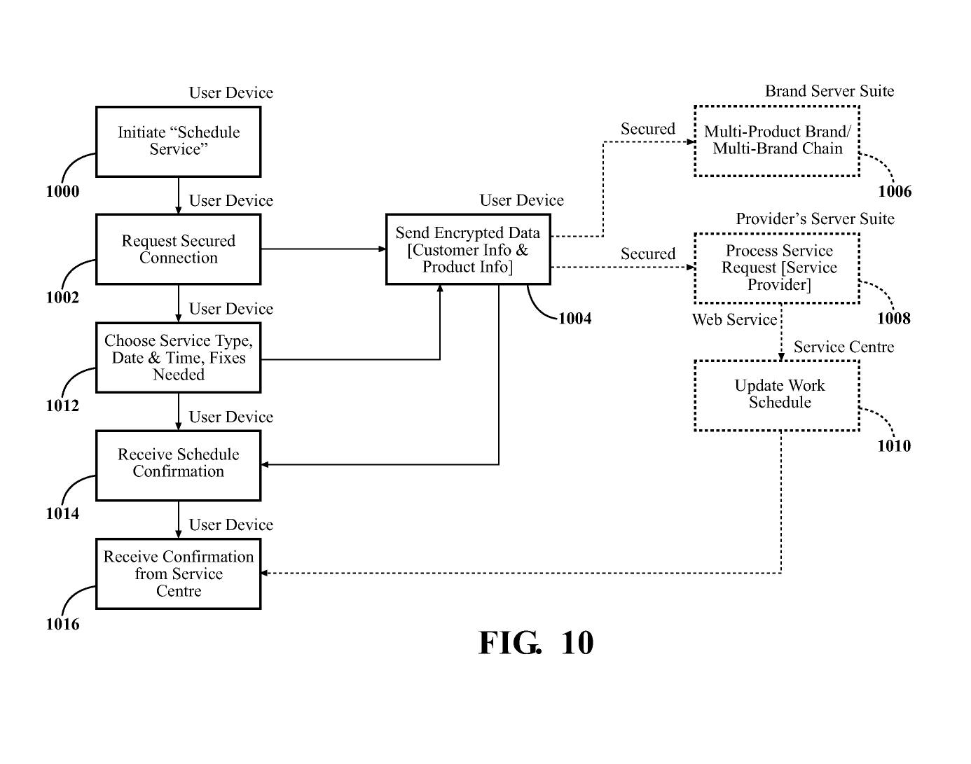

FIG. 10 depicts a flowchart illustrating a method for utilizing an entitlement service via a user application in accordance with an embodiment of the methods and systems disclosed herein. In embodiments, the consumer may initiate a schedule service request via the user application 1000. In response to the request, the user application enables the consumer to choose one or more of a service type, a type of fix, a choice of data and time for rendering the service at a service center 1012. The user application then requests a secured connection to the server 1002, which includes at least one of the brand's server suite 1006 and the cloud service. The user application sends the product information and the consumer information as encrypted data to the server 1004. On receiving the encrypted data, the server processes the schedule service request 1008 and updates a work schedule 1010 at the service center pertaining to the schedule service request. The user application then receives a notification pertaining to the schedule service request from the service center 1014 1016.

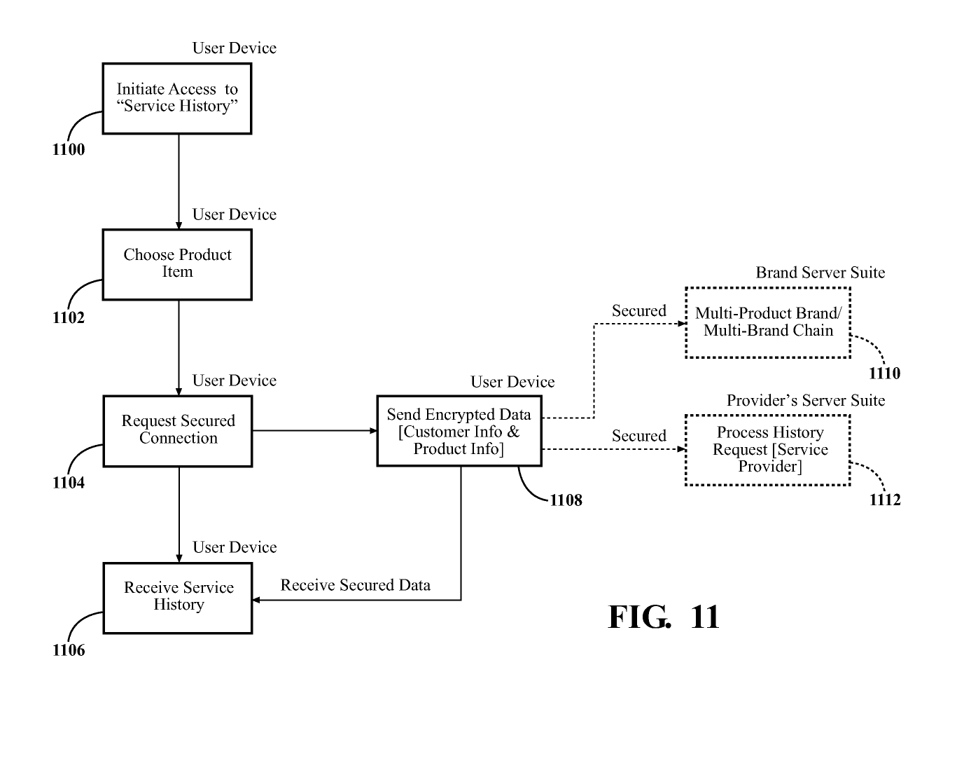

FIG. 11 depicts a flowchart illustrating a method for accessing an entitlement service history via a user application in accordance with an embodiment of the methods and systems disclosed herein. The consumer may initiate an access service history request via the user application 1100. In response to the request, the user application allows the consumer to choose a product item 1102. The user application then requests a secured connection to the server 1104, which includes at least one of the brand's server suite 1110 and the cloud service. The user application sends the product information and the consumer information as encrypted data to the server 1108. On receiving the encrypted data, the server processes the access service history request 1112 and sends the entitlement service history to the user device via the user application 1106.

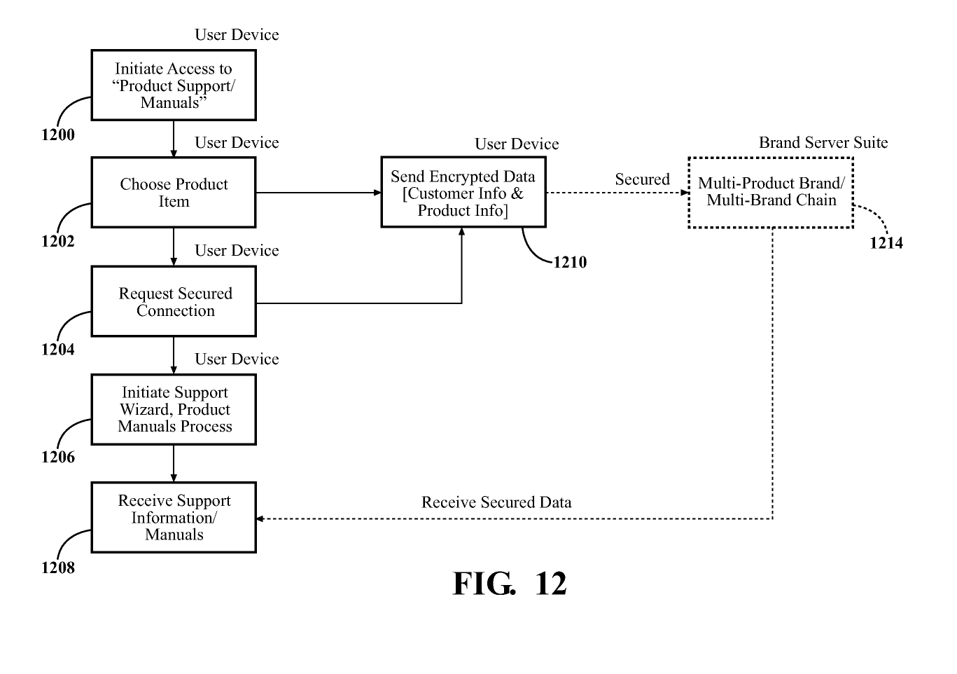

FIG. 12 depicts a flowchart illustrating a method for accessing product support/manuals via a user application in accordance with an embodiment of the methods and systems disclosed herein. The consumer may initiate a request for accessing the product support/manuals via the user application 1200. In response to the request, the user application allows the consumer to choose a product item 1202. The user application then requests a secured connection to the server 1204, which includes at least one of the brand's server suite and the cloud service 1214. The user application then initiates the support wizard and product manuals process 1206 and sends the product information and the consumer information as encrypted data to the server 1210. On receiving the encrypted data, the server processes the request and sends the product support content/manuals to the user device via the over the network 1208.

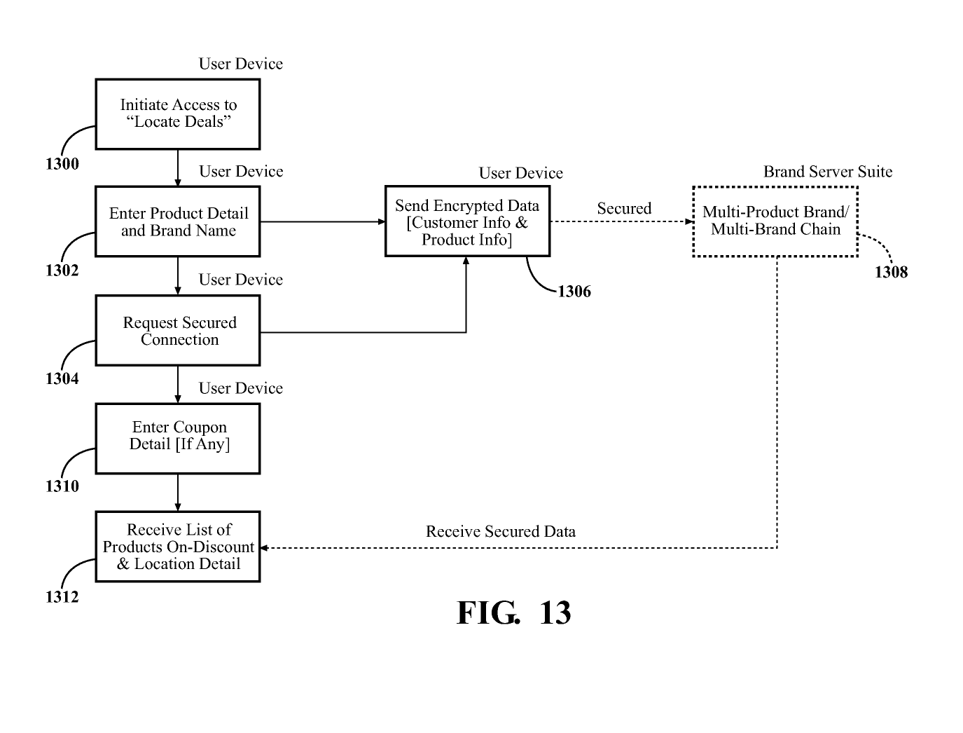

FIG. 13 depicts a flowchart illustrating a method for locating on-sale deals via a user application in accordance with an embodiment of the methods and systems disclosed herein. The consumer may initiate a request for locating and accessing deals via the user application 1300. In response to the request, the user application allows the consumer to enter a product detail and a brand name 1302. The user application then requests a secured connection to one or more cloud servers 1304, which includes the brand's server suite 1308. Further, the user application can also allow the consumer to enter a coupon detail 1310. The user application sends the product information and the consumer information as encrypted data to the cloud servers 1306. On receiving the encrypted data, the one or more cloud servers process the request. In response to the one or more cloud servers processing the request, the user application receives a list of products on discount and location details of the list of products from the cloud servers 1312.

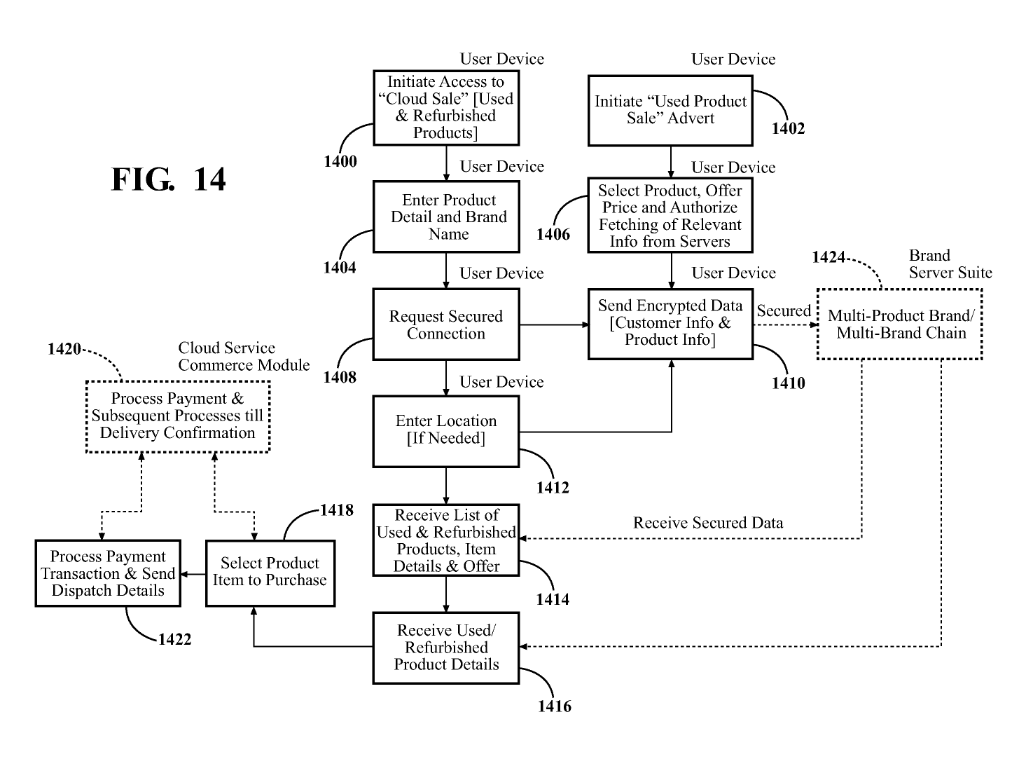

FIG. 14 depicts a flowchart illustrating a method for accessing a cloud sale service via a user application in accordance with an embodiment of the methods and systems disclosed herein. The consumer may initiate a request for locating and accessing a cloud sale of used and refurbished products via the user application 1400. In response to the request, the user application allows the consumer to enter a product detail and a brand name 1404. The user application then requests a secured connection to the one or more cloud servers 1408, which includes the brand's server suite 1424. Further, the user application can also allow the consumer to enter location information 1412. The user application sends the product information and the consumer information as encrypted data to the one or more cloud servers 1410. On receiving the encrypted data, the one or more cloud servers processes the request. In response to the one or more cloud servers processing the request, the user application receives a list of used/refurbished product details from the one or more cloud servers 1414. Further, the user application can also initiate a cloud sale advert request, which includes allowing the consumer to select a product 1418 and offer price and authorizing fetching of relevant information from one or more servers. In embodiments, refurbished product details may be received 1416 and payments processed 1420 1422.

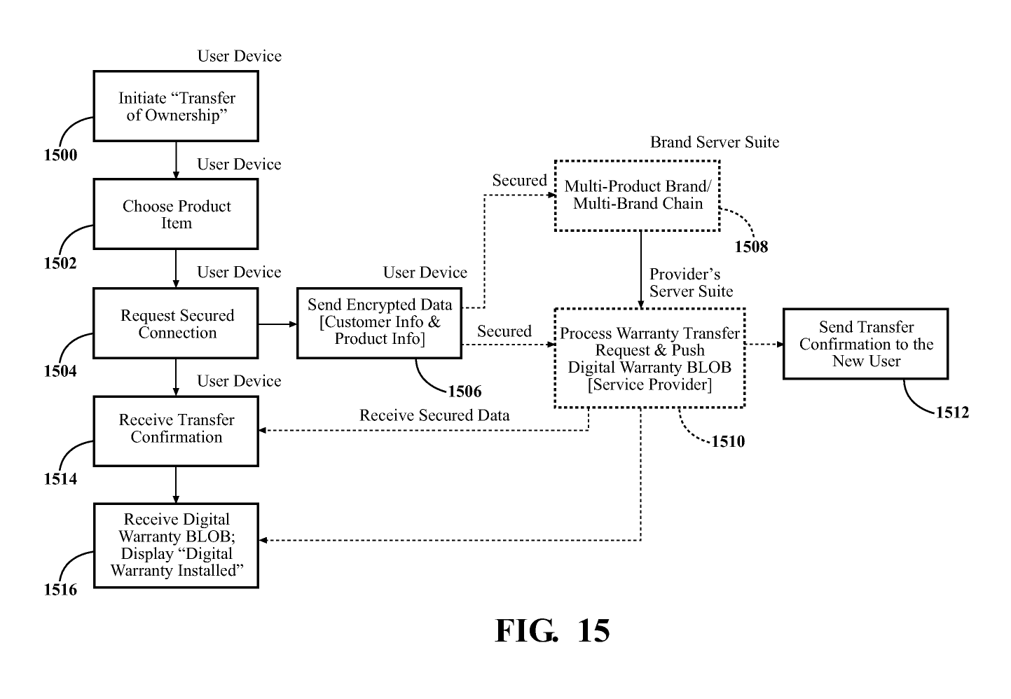

FIG. 15 depicts a flowchart illustrating a method for transferring an ownership of a warranty via a user application in accordance with an embodiment of the methods and systems disclosed herein. The consumer may initiate a request initiating a transfer of ownership of a warranty via the user application 1500. Upon the user choosing a product item 1502, the user application then requests a secured connection to the brand's server suite 1504. Further, the user application can also allow the consumer to enter location information. The user application sends the product information and the consumer information as encrypted data 1506 to the brands' server suite 1508. On receiving the encrypted data, the brand's server suite processes the request 1510. In response to the brand's server suite processing the request, the brand's server suite pushes a digital warranty BLOB to a new user and sends a confirmation of the ownership transfer to the user device via the network 1516. Transfer confirmation may be sent to the new user 1512 and confirmed to the user device making the transfer 1514.

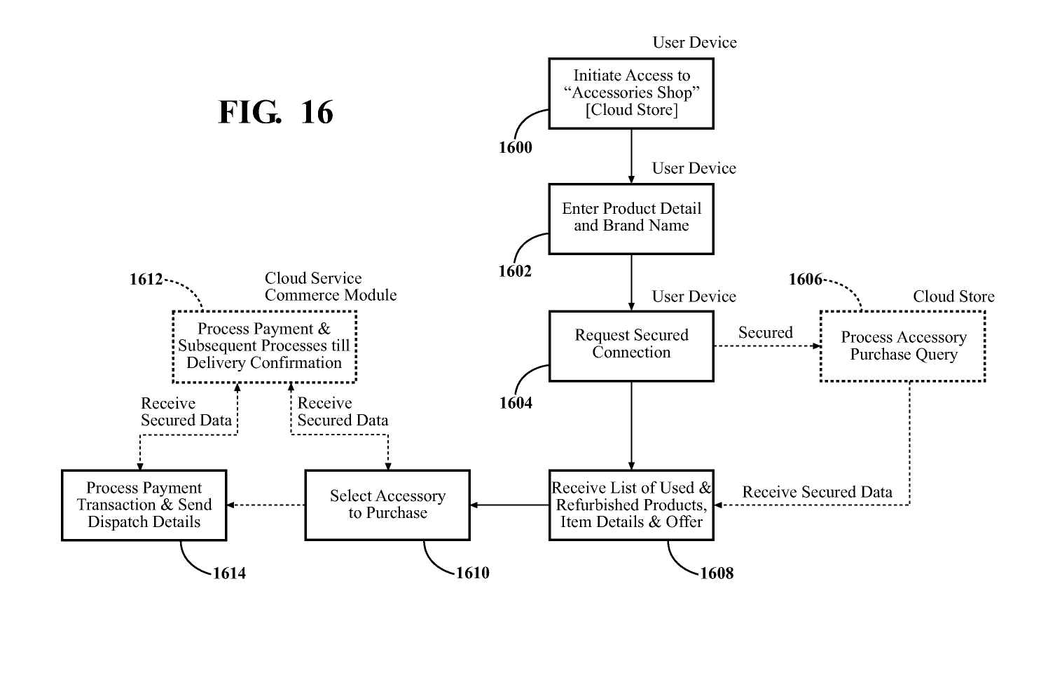

FIG. 16 depicts a flowchart illustrating a method for accessing an accessory cloud shop via a user application in accordance with an embodiment of the methods and systems disclosed herein. The consumer may initiate a request for accessing an accessory cloud shop via the user application 1600. In response to the request, the user application allows the consumer to enter a product detail and a brand name 1602. The user application then requests a secured connection to a cloud store 1604. The user application sends the product information and the consumer information as encrypted data to the cloud store. On receiving the encrypted data, the cloud store processes the request 1606. In response to the brand's server suite processing the request, the user application receives a list of used/refurbished product details and offer from the cloud store 1608. Further, the user application enables an interaction of the consumer with a cloud service ecommerce module by enabling the consumer to select an accessory to purchase 1610. Thereafter, the user application receives payment transaction details from the consumer for the accessory purchase 1612 and transfers the payment transaction details and dispatch details to the cloud service ecommerce module for processing 1614. The user application then receives a confirmation of the purchase of the accessory from the cloud service ecommerce module.

The methods and systems disclosed herein can also be utilized to enable the user to utilize a plurality of services corresponding to a plurality of products via a user device.

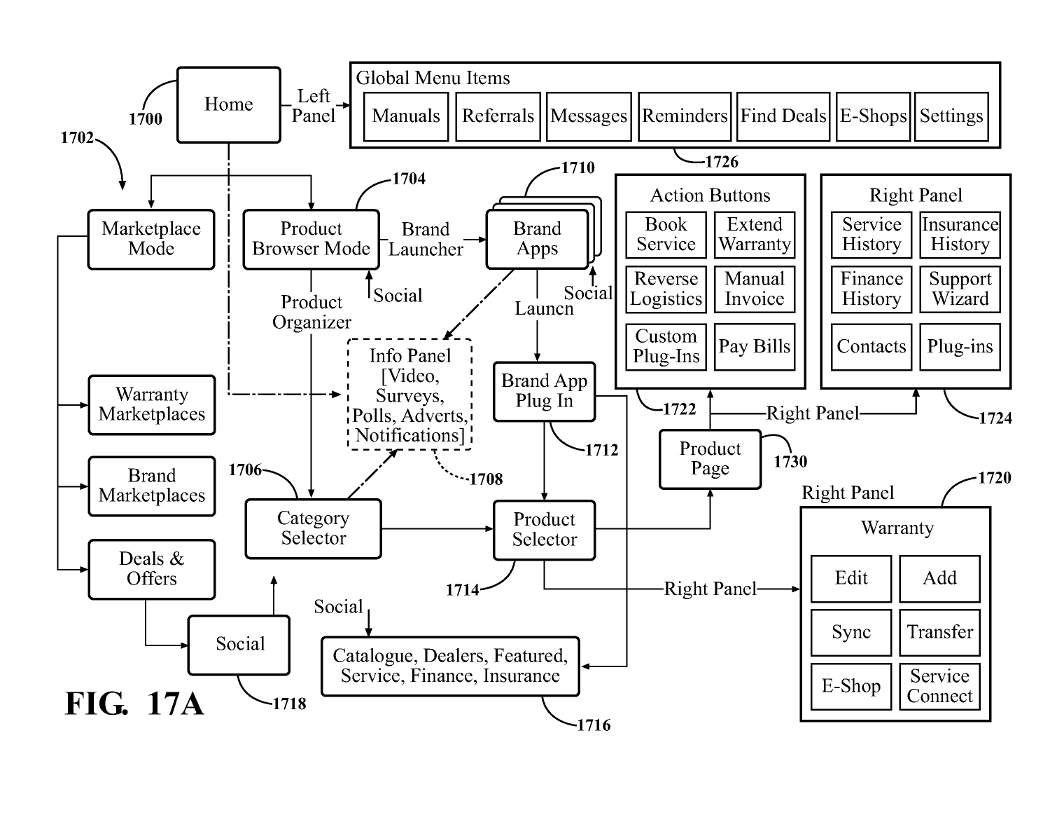

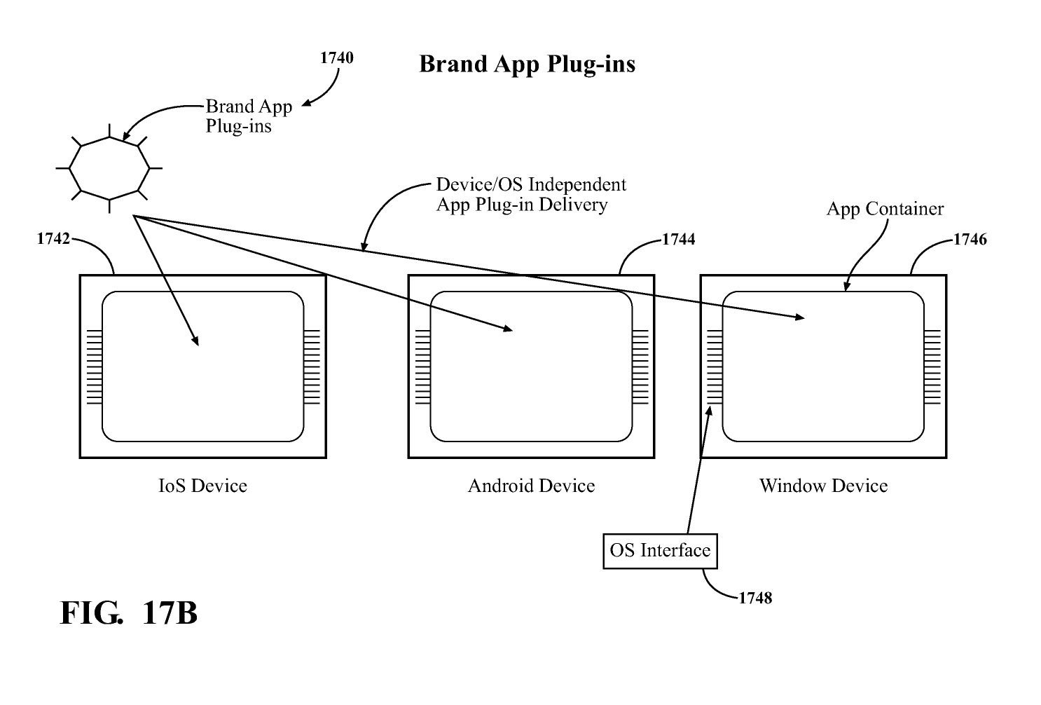

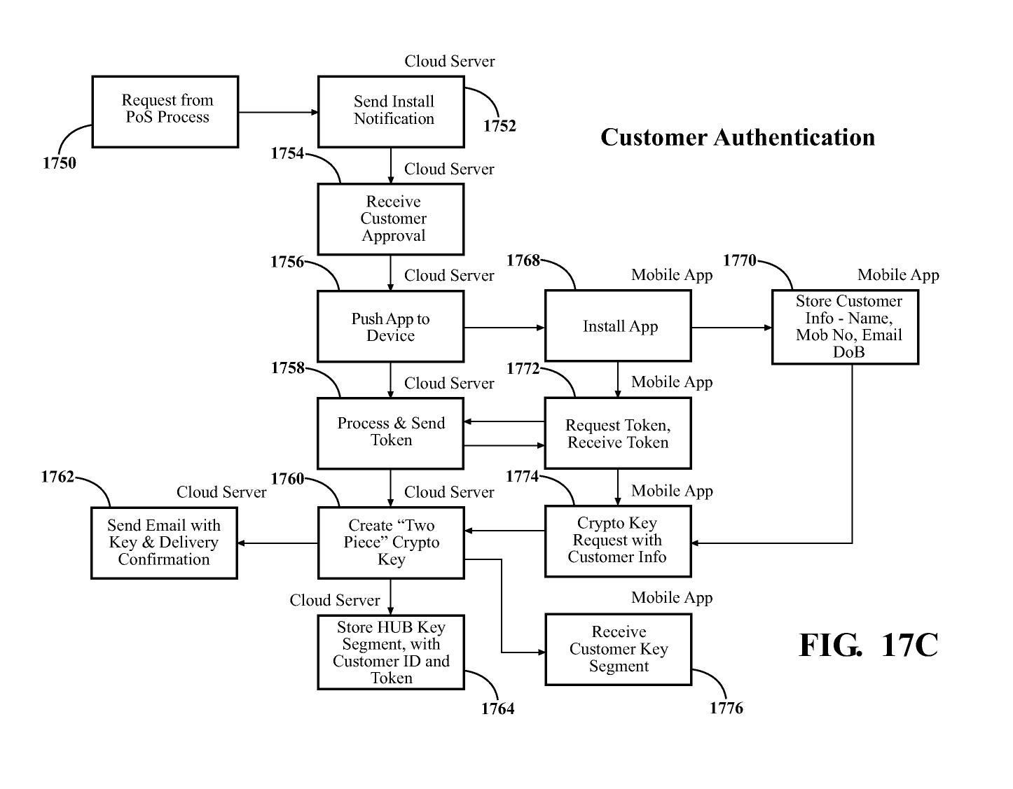

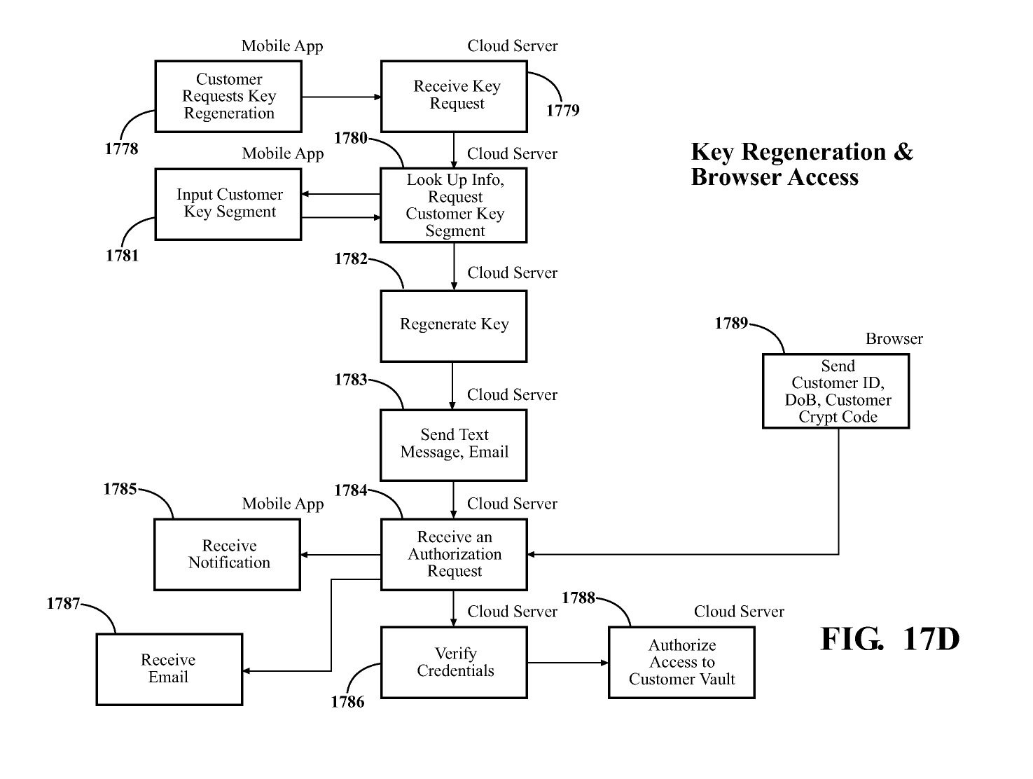

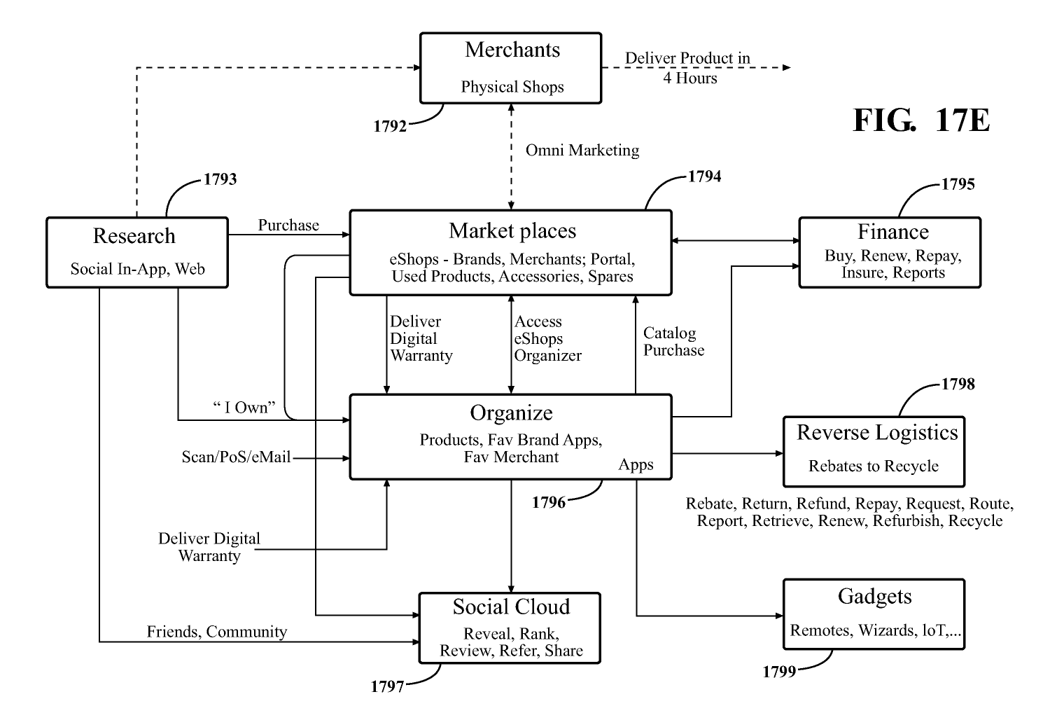

FIG. 17A illustrates an architecture for enabling the user to utilize the plurality of services via the user device in accordance with an embodiment of the methods and systems disclosed herein. As illustrated, the user interface may enable the user to view and access one or more items associated with the plurality of products via a home screen 1700. The one or more items include, but need not be limited to, one or more global menu items 1720, one or more product items 1722 one or more product registration items 1718, and one or more global product items 1724. The one or more global menu items 1720 include, but need not be limited to, one or more manuals, one or more favorites, one or more messages, one or more reminders, one or more find deals, one or more cloud sales and one or more settings. The one or more product items 1722 include, but need not be limited to, a book service, an extend warranty, a reverse logistics, a user manual and an add notes feature. The one or more product registration items 1718 includes features such as, but need not be limited to, an add product, an edit product, a transfer product, a sync warranty, an invoice capture and a QR scan. The one or more global product items 1724 include, but need not be limited to, a service history, a product support, one or more contacts, an add location feature and an add notes feature. In product browser mode 1704, the user interface enables the user to select at least one of a category 1706 and a product 1714 on the home screen of the user device in order to view and access the one or more items 1730 associated with the plurality of products in order to utilize the plurality of services. In marketplace mode 1702, the user device enables the user to view and access warranty marketplaces, brand marketplaces, and deals and offers. Various embodiments of the methods and systems disclosed herein provide methods and systems for enabling a user to utilize a service associated with a product purchased via a digital object. Further, the digital object can be used as a digital evidence of verified ownership for the user. The user can accordingly utilize the digital object to claim entitlements. In embodiments, as depicted in FIG. 17B, the plurality of services offered by the platform, as described herein, may be delivered through an application, referred to herein as the Brand App. The Brand App plug-in 1740 may operate over a plurality of operating systems, for example iOS 1742, Android 1744, Windows 1746, or some other operating system. A Brand App 1710 plug-in implementation may contain an OS interface 1748.

As shown in FIG. 17C, the platform, as described herein, may include a customer authentication process. In an example, a request from a point-of-sale process 1750 may be received. The request may be received by a cloud computing-based server whereupon an installation notification 1752 may be sent and a customer approval process completed 1754 after which a mobile application, such as the Brand App as described herein, may be sent to a device 1756. The mobile application may be installed 1768 on the device from which customer data, contact information and the like 1770 may be accessed. The mobile application may request and receive a token 1772, from a cloud computing-based server running a token process 1758. The mobile application may request a crypto key with customer information 1774 from a cloud-based server at which a two-piece crypto key is created 1760. The mobile application may receive the customer key segment 1776, and the cloud-based server may store a HUB key segment containing the customer identifier(s) and token 1764. An email may then be generated with the key and a confirmation of delivery 1762.

As shown in FIG. 17D, the platform, as described herein, may include a key regeneration and browser access process. In an example, a cloud-based server may receive a key request 1779 from a mobile application sending a customer request for a key regeneration 1778. At the cloud-based server, an information query may be conducted and a customer key requested 1780. The customer key segment may be input within the mobile application running on a device 1781. Next, the cloud-based server may regenerate a key 1782 and send a text, email or some other type of message 1783, and receive an authorization request 1784. The authorization request may be further associated with data relating to customer identifiers, contact information and the like 1789. The customer credentials may then be verified at the cloud-based server 1786, and access to a customer vault authorized 1788. The cloud-based server may send a notification 1785, email 1787, or some other type of communication indicating authorization was completed.

As shown in FIG. 17E, the platform, as described herein, may include marketplaces 1794, such as e-commerce shops, shopping portals and the like. The marketplaces 1794 may be associated with merchants 1792 operating physical, brick-and-mortar-type shops, finance 1795 and research 1793 operations, including but not limited to banking and insurance, and social media research entities. Mobile applications, such as the Brand App and/or plurality of Brand App's may be organized 1796 and connectivity to social media 1797 and digital gadgets 1799 provided, such as installation wizards or some other digital gadget, plug-in or the like. Reverse logistics 1798, such as rebates, refunds and the like may be provided.

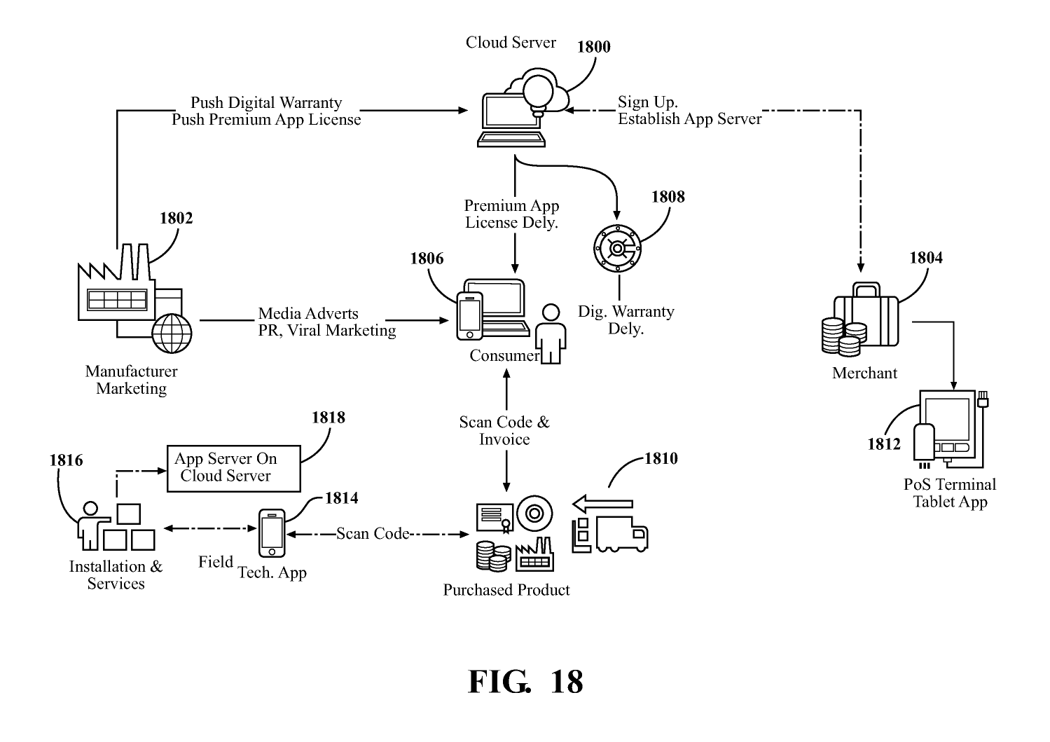

FIG. 18 illustrates architecture and a non-limiting example for enabling a user to enforce product registration, driven by a process initiated by the manufacturer. In embodiments, a Point of Sale terminal 1812 may be used by a merchant 1804 to establish a connection with a cloud server in order to initiate and establish product registration 1800. The Point of Sale terminal may be embodied in the form of a mobile device application, among others. A user may access the cloud server through a variety of means, including, but not limited to, a mobile application 1806. The user 1810 may scan a code identifying a purchased product, which may in turn cause the cloud server to deliver the product to the consumer. A marketer 1802 may in turn be incentivized by the cloud server to communicate or advertise to the user through a variety of different channels in order to market the product to the user. The architecture may include a PoS terminal table app 1812, a merchant 1804, a cloud server 1800, a consumer 1806, a manufacturer marketing 1802, a purchased product 1810, a field technology application 1814, installation and services 1816, an application server on the cloud server, and so forth. PoS terminal table app may be in communication with merchant or other seller. Merchant and cloud server may exchange sign-up information and establish app server information. A cloud server 1800 may send premium app license delivery and digital warranty delivery information 1808 or similar to the consumer. Manufacturer marketing 1802 may send digital warranty and premium app license information to the cloud server 1800 on behalf of the purchaser or user 1806. Manufacturer marketing 1802 may send information, such as media advertisements, PR, viral marketing information, and so forth, to the consumer 1806. A consumer 1806 may exchange scan code and invoice information from the purchased product 1810. The purchased product 1810 may provide scan code information and the like with the field tech app 1814. The field tech app 1814 may also exchange information with installation and services 1816. Installation and services 1816 may send information to app server on a cloud server 1818, etc.

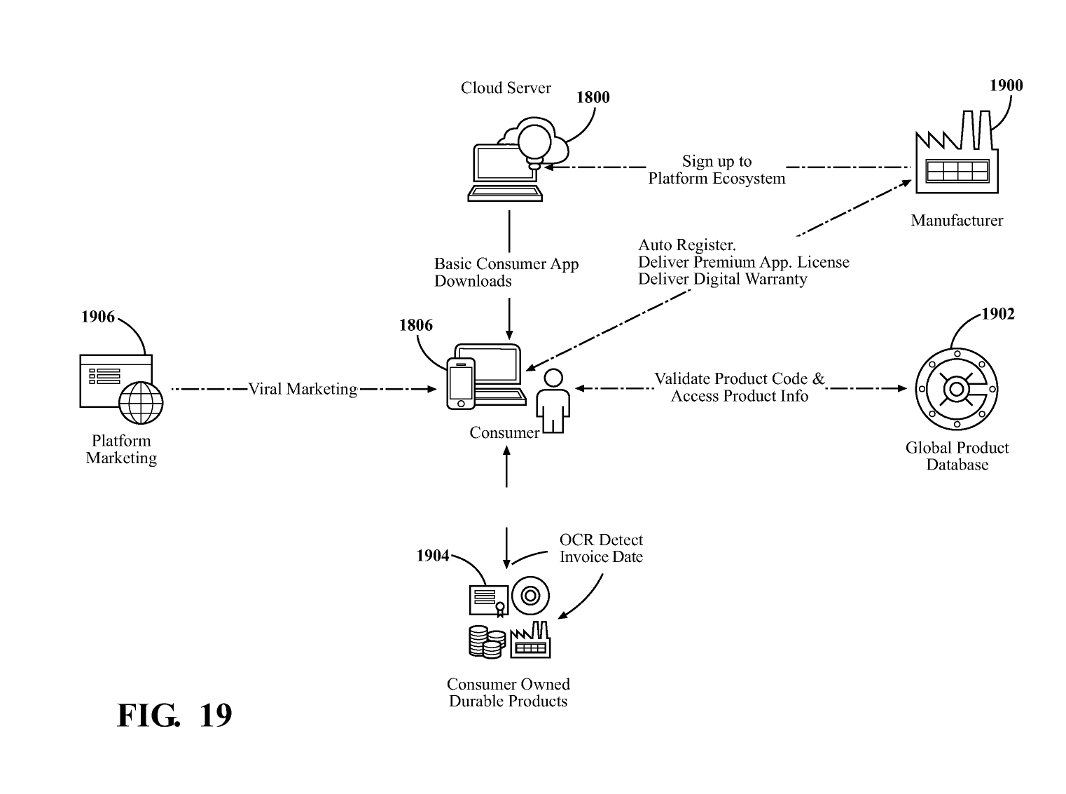

FIG. 19 illustrates architecture and a non-limiting example for enabling a user to enforce product registration, driven by a process initiated by cloud server 1800. The architecture may include a consumer 1806, platform marketing 1906, a cloud server 1800, a manufacturer 1900, a global product database 1902, consumer owned durable products 1904, and the like. Platform marketing 1906 may send viral marketing information and other information to the consumer 1806. A cloud server 1800 sends basic consumer application download information and other information to the consumer 1806. A manufacturer 1900 may send sign up forms to a platform ecosystem information area, and the like, to the cloud server 1800. Manufacturer 1900 may also exchange auto register, deliver premium app license, and deliver digital warranty information with consumer 1806. Global product database 1902 may exchange validate product code and access product info information with consumer 1806. Consumer owned durable products 1904 may provide scan code and invoice information, among other information, with the user or consumer 1806. OCR detected invoice data information may be used to communicate scan code and invoice information.

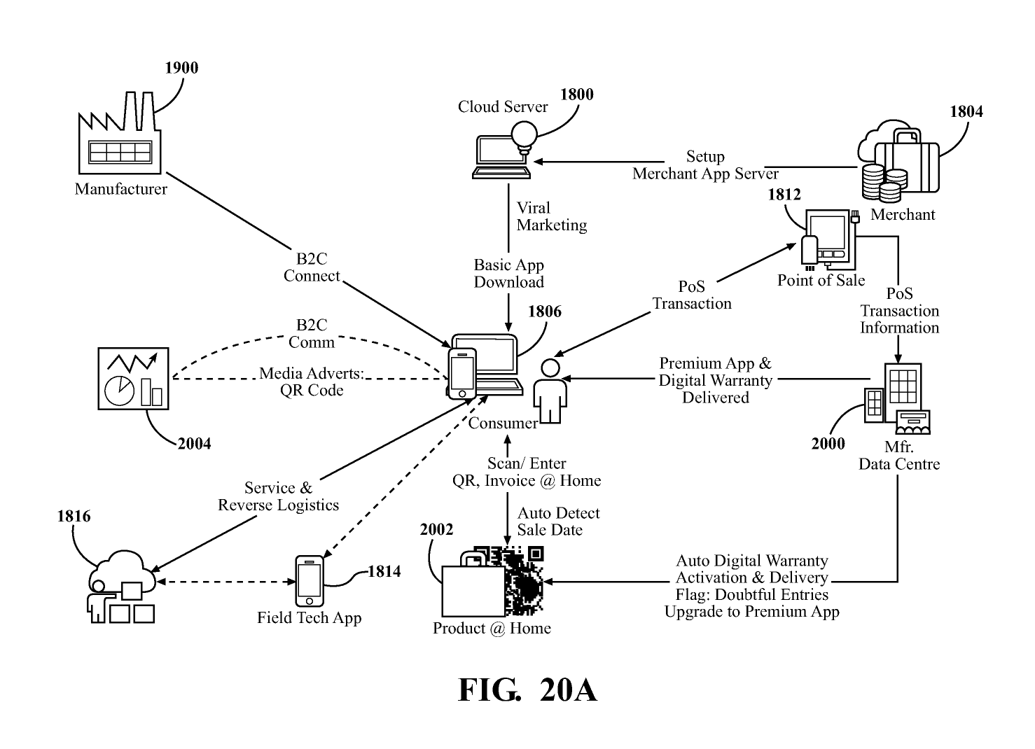

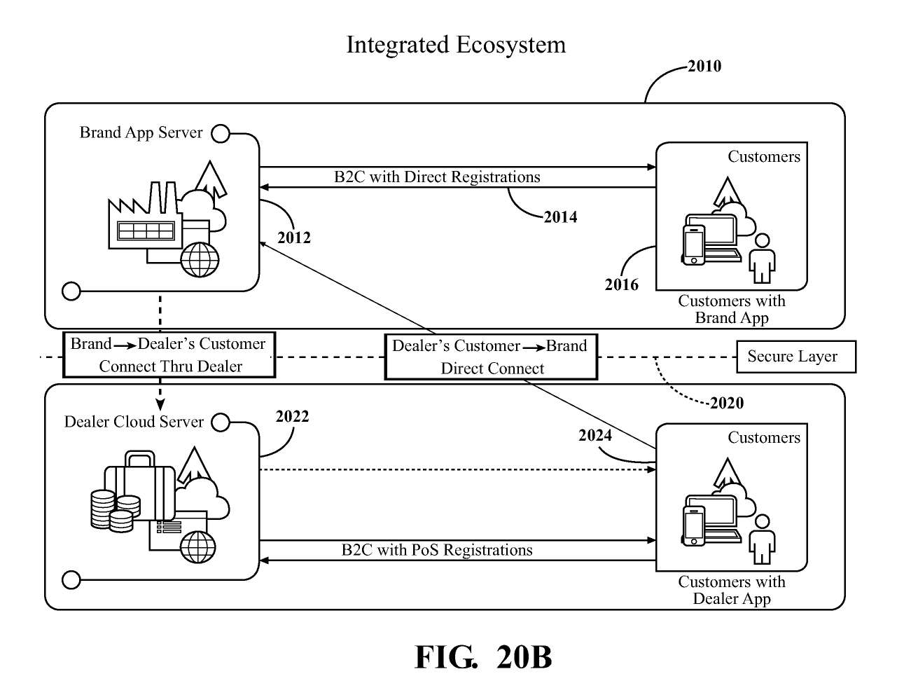

FIG. 20A illustrates architecture and a non-limiting example for various customer touch-points that aid product registration. The architecture may include a consumer 1806, marketing and media advertisements 2004, a manufacturer 1900, a cloud server 1800, a point of sale 1812, a merchant 1804, a manufacturing data centre 2000, products @ home 2002, field tech application 1814, or installation and services and reverse logistics 1816. A manufacturer 1900 may send B2C connect information to consumer 1806. Cloud server 1800 may send viral marketing and basic app download information to the consumer 1806. Merchant 1804 may send setup and merchant app server information to the cloud server 1800. Point of sale 1812 may exchange PoS transaction information with consumer 1806. Point of sale 1812 may also send PoS transaction information to a manufacturing data centre 2000. The manufacturing data centre 2000 may send auto digital warranty, activation and delivery indications; flag: doubtful entries, and upgrade to premium app information to products @ home 2002. Products @ home 2002 may exchange scan/enter QR, invoice @ home, and auto detect sale data information with consumer 1806. Field tech application 1814 may exchange information with installation and services 1816 consumer 1806 and as desired. Installation and services 1816 may exchange service and reverse logistics information with the consumer. Marketing and media advertisements 2004 may send B2C communication, media advertisements, and the like to the consumer 1806. Media advertisements 2004 may be QR code advertisements or others as deemed useful by the manufacturer or the marketers.

FIG. 20B illustrates the integrated ecosystem 2010 of the platform, wherein the Brand App Server 2012 may provide for direct registrations 2014 with a customer 2016. A Dealer Cloud Server 2022 may also be provided for making point-of-sale registrations with customers 2024, for example by using a dealer application. The Brand App Server 2012 and the Dealer Cloud Server 2022 may communication with each other, for example through a secure layer 2020. Customers 2024 utilizing the dealer application may also communicate with the Brand App Server 2012.

In embodiments, a customer may input a code of a product that is at the home of the customer. The code may be a bar code, QR code or alpha-numeric identifier. Code may be input by scanning the code, inputting the code manually, reading by an RFID reader and so on. A customer may then scan the invoice, purchase bill, or other information that is provided. The methods and systems described herein may then detect the sale date, product number and the like using optical character recognition (OCR) on the scanned invoice. The code, sale date, product number and other information may then be sent with consumer data to the manufacturer server through the cloud server. The cloud server may then validate and correlate the information and prepare a digital warranty BLOB specific to the product and the customer. This correlation may establish a relationship between a customer and a product. In certain embodiments correlation between a customer and a product may be based on the physical proximity of a device, such as the user's device that stores a digital object that allows access to services, to a product, such as a product located near similar GPS coordinates to the device or within near field communications range of a device. The relationship may allow access to the service related to the product. Thus, in some embodiments a user device, such as a cellular phone, in storing the digital object, may be transformed to a special purpose device capable of enabling access to services related to a physically proximate product.

Returning to the example, the application server may push the digital warranty BLOB to the user application. A premium application license may then be delivered to the user application to enable advanced app features.

In the case of doubtful OCR detection of the purchase date and model number of a product, the item associated with the doubtful OCR may be flagged or other alert may be made. If an item associated with the doubtful OCR is flagged, the field technician may cross check the invoice, update records, or otherwise check the information. The field technician may cross check the invoice or update records, on the next visit to the customer by the field technician. Once an item associated with a product is updated the premium application license is delivered to the user application and enables advanced application features.

In embodiments, the methods and systems disclosed herein may facilitate providing digital insurance. In embodiments, a digital object may be configured to include information that enables a user to utilize a digital insurance service. In embodiments, the digital object may be used to manage services associated with an insurance product. Subsequently the digital object may be used to facilitate digital insurance by providing access to and information derived from various insurance products utilizing a digital insurance service. Specifically, digital insurance may comprise, but is not limited to, providing information about an insurance product, advising a user about the insurance product, facilitating the purchase of the insurance product, taking and processing information that allows underwriting and/or pricing the insurance product, providing customer service in connection with the insurance product, and filing claims associated with the insurance product, among others. Information contained in the digital object for utilizing and deploy a digital insurance service may comprise a cryptographic wrapper representative of the digital insurance service and representative information. The digital insurance cryptographic wrapper may comprise one or more of, but is not limited to, a unique insurance ID, a profile, other cryptographic wrapper data, contact details, purchase data, invoice data, transaction data, support hyperlinks, media & images, and entitlement profiles. In embodiments, information and advice directed to digital insurance may be obtained through several channels, including, but not limited to, direct in-person channels, a call center, classic internet resources e.g. a website, online communities, online chat including video chats, or mobile applications. In embodiments, the digital insurance digital object may be associated with a consumer application module. The consumer application module may interact with one or more server suites in the cloud based server network. The one or more server suites may comprise information from insurance marketplaces, where digital insurance may be purchased from insurance companies and their respective IT infrastructures. Insurance agents, insurance companies, and insurance service providers may provide custom modules via their respective IT infrastructures to the cloud based server network and may send digital objects comprising information relevant to a digital insurance request in order to facilitate providing insurance products to digital insurance users. This information may be accessed by a digital insurance consumer via the consumer application module on a user's device. The methods and systems disclosed herein may facilitate the purchasing of digital insurance via the consumer application module. The consumer application module may also facilitate connecting a digital insurance consumer to customer service, or facilitate the filing of insurance claims.

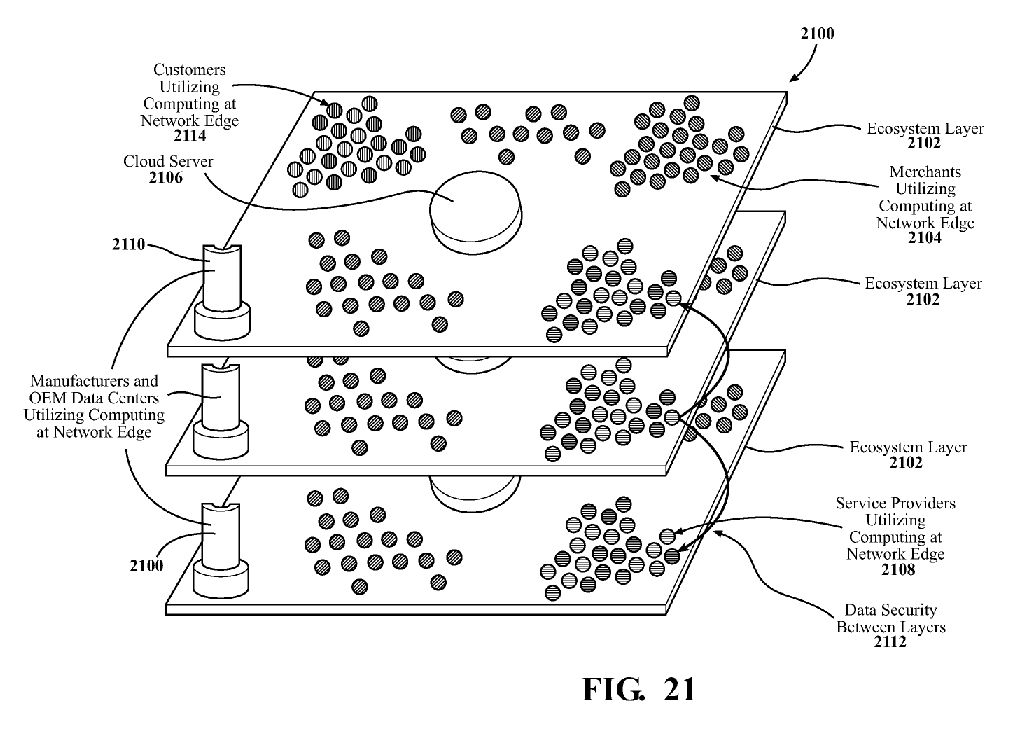

FIG. 21 illustrates an ecosystem enabling a user to associate a service with a product and to utilize a service associated with a product in accordance with an embodiment of the methods and systems disclosed herein. In the ecosystem, each manufacturer, original equipment manufacturer (OEM), or other provider may create its own ecosystem. The manufacturer or the OEM may be a creator of an ecosystem. The ecosystem may consist of merchants, service providers, consumers, service providers, or original service providers. Original service providers may be insurance companies or other vendors or providers of services. An ecosystem may include ecosystem layers 2102. An ecosystem layer 2102 may be an exclusive and secured ecosystem layer. The ecosystem of each creator may not be accessible to another creator. A merchant app server may have access to and consolidate data from multiple ecosystem system layers 2102. Service providers may also have access to and consolidate data from multiple ecosystem layers 2102.

With further reference to FIG. 21, computing may be performed at the network edge. Computing performed at the network edge may ensure secured data ownership to the data originator and data receiver. Computing performed at the network edge may be performed within a fog computing environment. A data originator may be a manufacturer, merchant, service provider or consumer. A data receiver may be a manufacturer, merchant or a service provider or a consumer. SME merchants and retailers may choose to use the cloud server to reduce the cost of running a computing node at the edge of the network of the SME merchant or retailer, for example running a computing node in the data centre or on the premises of the SME merchant or retailer. Vault owners may own a vault at the cloud server. Vault owners may be consumers, SME merchants or SME retailers, or similar. Vault may have a vault type. Vault type may be computing vault or a storage vault. Vault type may be chosen by vault owners.

The ecosystem may consist of ecosystem layers 2102 of exclusive, secured networks owned by secure network owners. Secure network owners may be manufacturers, OEM's, service providers, original service providers, or others. The ecosystem layer 2102 may consist of a data centre, merchants, agents, service centers, other service providers and consumers.

The ecosystem layer 2102 may be an exclusive, secured environment, controlled and configurable by an ecosystem layer controlling entity. The ecosystem layer controlling entity may be the manufacturer or OEM. Data may be owned by a data owner. A data owner may be a data originator or a data receiver. Data may always be under the control of the data owner. Data may be secured at all times. For example, data may be secured while “in-storage”, “in-process” or “in-transit”, at all times.

The manufacturer or OEM data centre may include the internal computing network of the manufacturer or OEM. The internal computing network of the manufacturer or OEM may consist of all computing nodes that operate behind the Data Centre firewalls. Computing nodes may be employee computers or other computers.

Ecosystem and ecosystem layer 2102 may have rules. Rules may be engagement rules, data flow rules, and interaction rules. Rules may be set by ecosystem creator, ecosystem layer controlling entity, as desired. Data may always be contained in an ecosystem layer 2102 and may not be exposed to other layers.

Manufacturers and OEM's may be limited to accessing a single ecosystem layer 2102. Every other participant in the network may not be limited to accessing a single ecosystem layer 2102 and may be allowed to access multiple ecosystem layers 2102.

In one exemplary and non-limiting embodiment, a multi-brand merchant may be doing business with many OEM's and may have access to different ecosystem layers 2102. While the app server of the merchant may consolidate and process all the data originating from different ecosystem layers 2102, inter-layer data flow may be restricted by a data valve located in the app server.

The data valve at the app server may scan the data headers and act as a firewall to restrict inter-layer data flow, ensuring that the data belonging to one ecosystem layer 2102 may not reach another ecosystem layer 2102 under any circumstance.

An ecosystem may include a relationships marketplace. Two manufacturers and OEM's, or others, may work out a cross-marketing deal using a relationships marketplace. In one exemplary and non-limiting embodiment, OEM A may deal in product A and OEM B may deal in product B. If a cross-marketing deal is worked-out between OEM A and OEM B using a relationships marketplace, OEM A may use the relationships marketplace to declare that OEM A is willing to establish a conditional cross marketing agreement with OEM B, OEM D, OEM M, and OEM X. OEM B may use the relationships marketplace to declare that OEM B is willing to establish a conditional cross marketing agreement with OEM A, OEM E, OEM N, and OEM Y. OEM A and OEM B may then declare conditions related to a conditional cross marketing agreement. A condition may be a rule. A rule may be a business rule. One such condition may be a 2:1 relationship for a relationship between OEM A and OEM B. A 2:1 relationship may allow OEM A to authorize OEM B to sell product B to a specific number of customers of OEM A, for example N customers of OEM A, and OEM B to authorize OEM A to sell product A to a specific number of OEM B customers, for example N/2 customers of OEM B. Customer equity of OEM A and OEM B may be mutually leveraged to increase the respective markets of OEM A and OEM B as a result of such a conditional cross marketing agreement being established between OEM A and OEM B. If two manufacturers or OEM's work out a cross marketing deal using a relationships marketplace, then the flow control mechanisms, which may include the data valves, of both the manufacturers and the OEM's, may work in tandem, through a handshake authorization process. The handshake authorization process may be necessary to authorize data header modifications, so that a first manufacturer or OEM may cross-market to the customers of a second manufacturer or OEM.

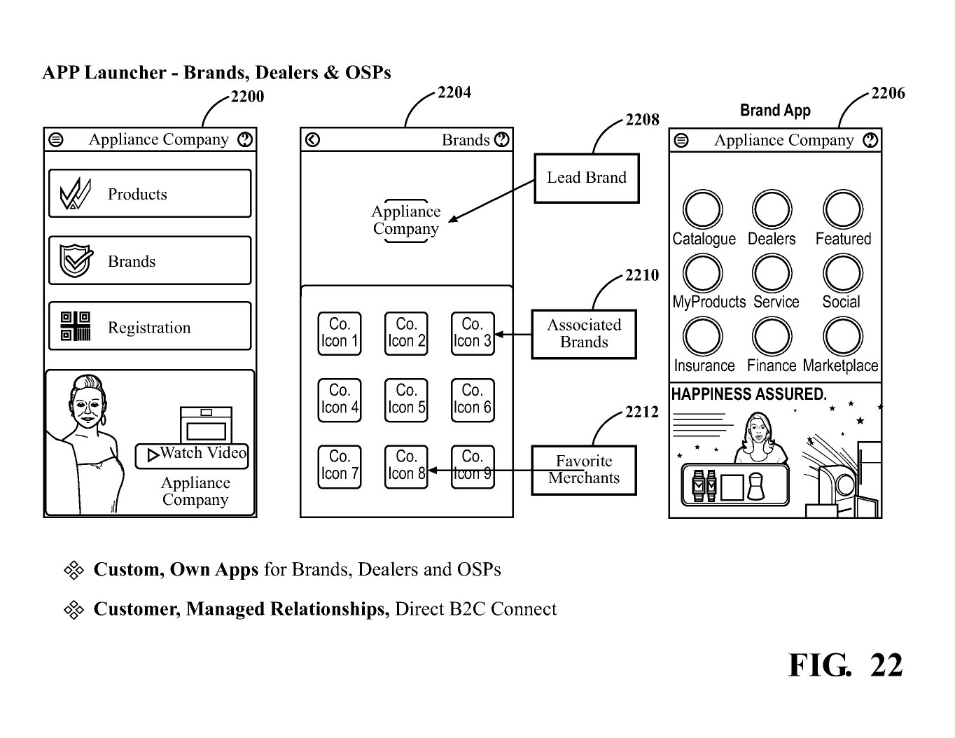

As depicted in FIG. 22, the platform may provide for an app launcher that includes a plurality of Brand Apps 2206. The Brand App content may be focused on a particular manufacturer, such as an appliance company in this example 2200 The Brand App may also present associated brands, such as General Electric and the like 2210, and/or preferred merchants at which such manufacturers' products may be purchased 2212. Brands 2204 may be presented in an organized format, including but not limited to the leading brands 2208 by sales, customer sentiment, or some other criterion.

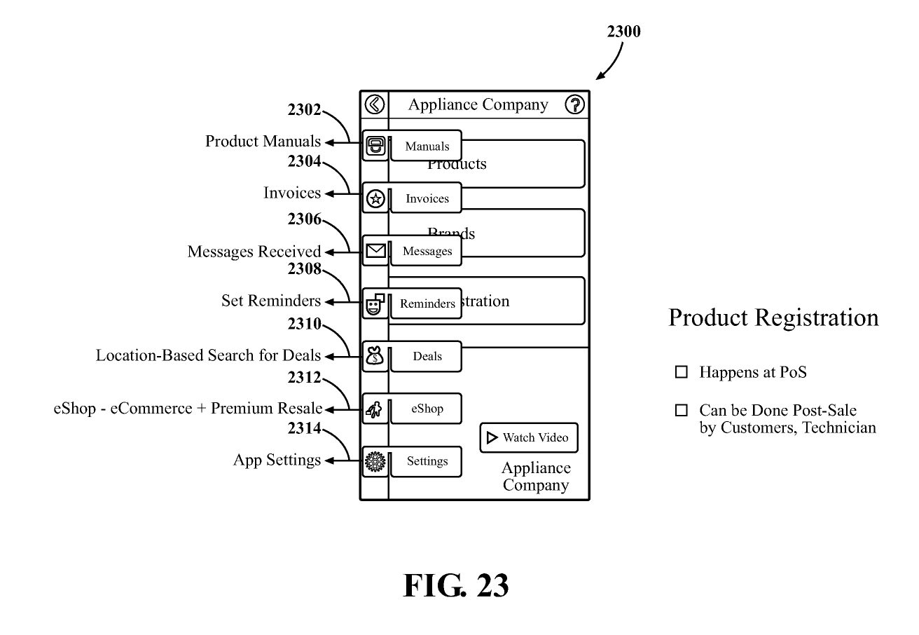

As depicted in FIG. 23, the platform may provide for product registration using, for example, the Brand App in which information such as product manuals 2302, invoices 2304, messages received 2306, reminders 2308, location-based searching 2310, e-commerce shopping 2312, and application settings are presented 2314.

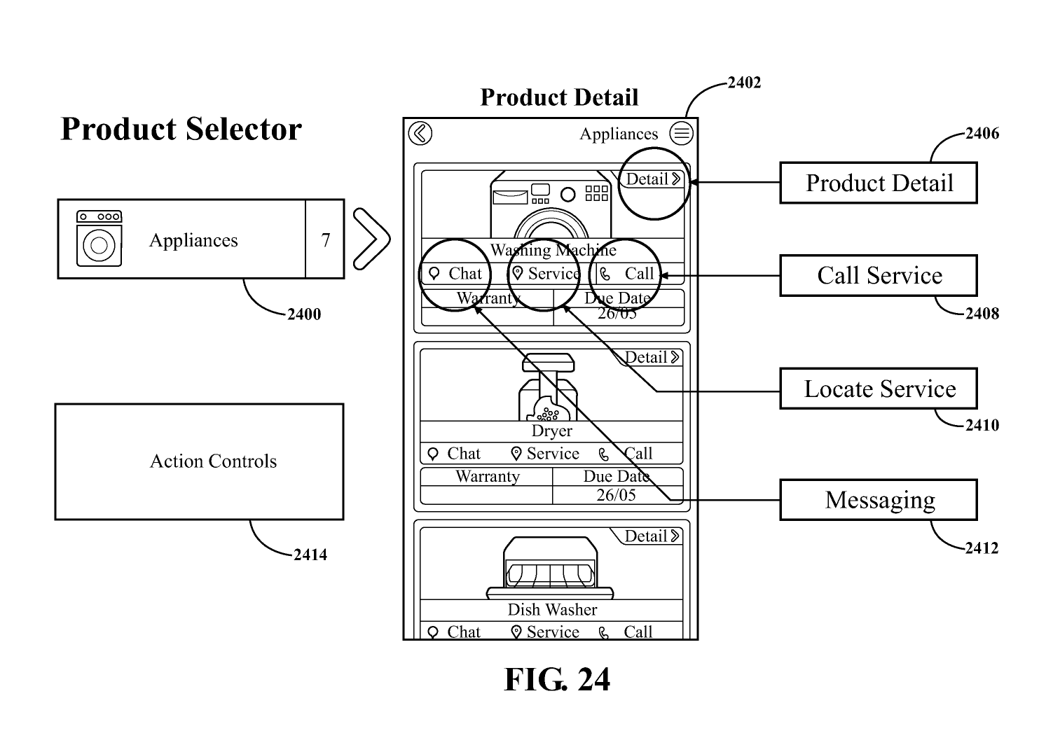

As depicted in FIG. 24, a product selector functionality 2402 may be presented with a Brand App in which information such as product details 2406, service calling 2408, service location 2410, and messaging 2412 may be provided for products such as appliances 2400. Action controls 2414 relating to the product selector functionalities may also be provided, such as placing a service call for an appliance based on a service provider's location.

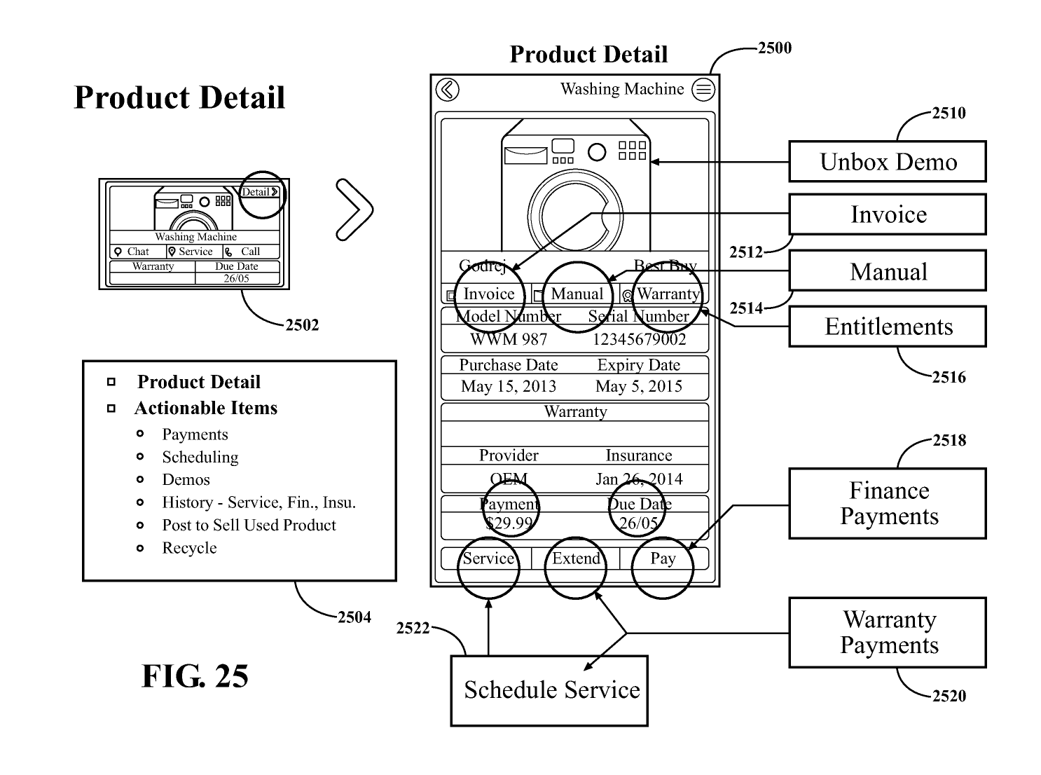

As depicted in FIG. 25, the Brand App may present product details 2500 relating to a product, such as a washing machine 2502, and actions that may be taken as related to that product 2504. The user interface of the Brand App may present a user information such as product demos 2510, invoices 2512, manuals 2514, entitlements 2516, information relating to financing 2518, warranties 2520, and product service schedules 2522.

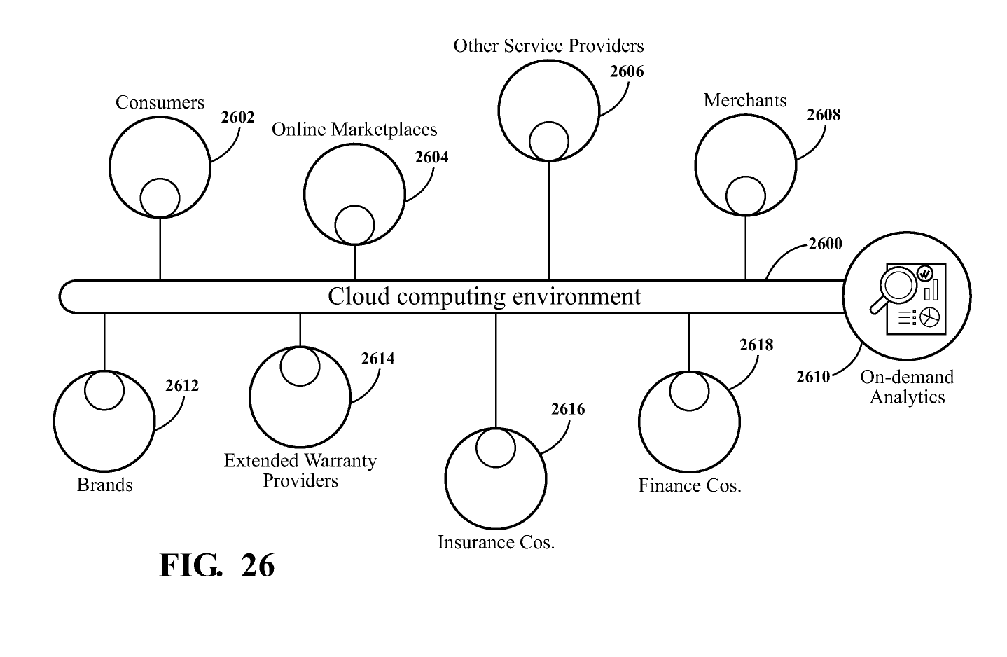

FIG. 26 illustrates the relationships among a plurality of entities and the cloud computing-based on-demand analytics. Entities, including but not limited to, consumers 2602, online marketplaces 2604, service providers 2606, merchants 2608, brands 2612, warranty providers 2614, insurance companies 2616, finance companies 2618, or some other type of entity may access and utilize on-demand analytics 2610 that are provided by the platform, such as through a cloud-computing environment 2600.

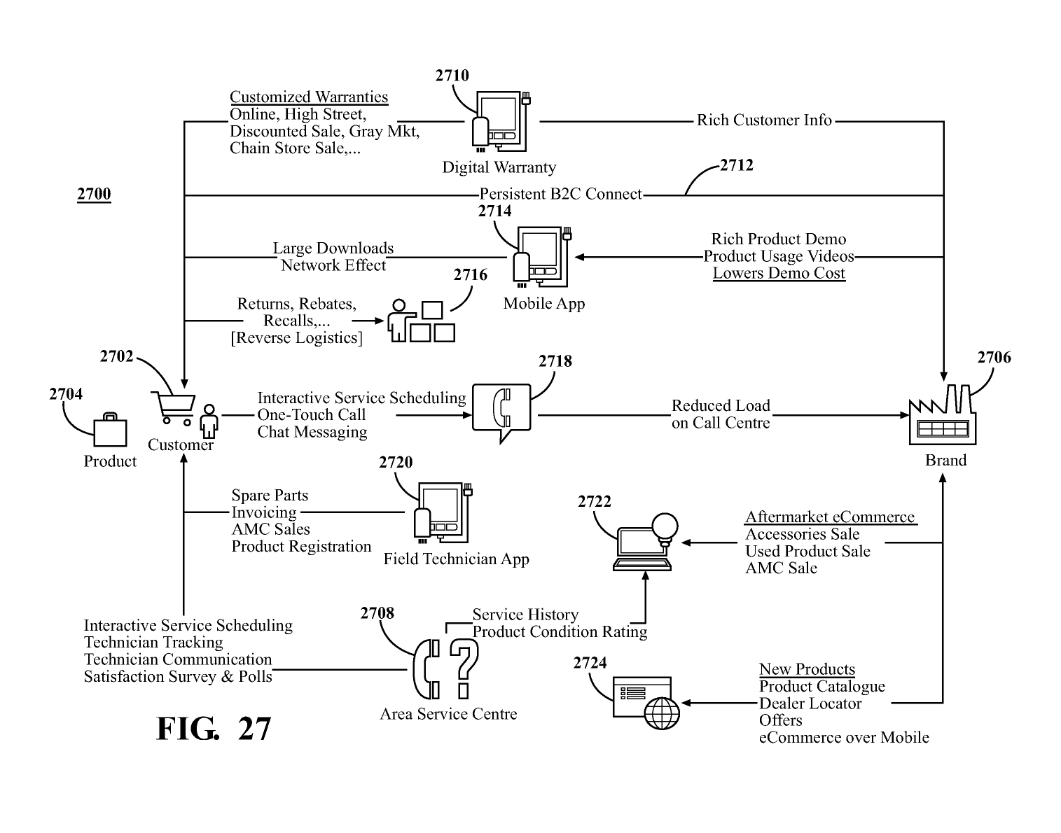

FIG. 27 illustrates a flow diagram of a consumer service scheduling process 2700 in which a customer 2702 may schedule a service call for a product 2704, such as an appliance. The customer may utilized a mobile application 2714, such as the Brand App, to maintain contact with a manufacturer or brand 2706 regarding a product 2704, including but not limited to, warranty information 2710, returns, rebates and the like (referred to herein as reverse logistics) 2716, e-commerce, including aftermarket e-commerce functions 2722, such as used products, as well as new product focused e-commerce 2724. The Brand App may retain a persistent business-to-customer connection 2712 with the customer 2702. A field technician may interact with the customer 2702 by utilizing a field technician application 2720 that is associated with the platform, and both the field technician and customer 2702 may utilize the applications that are associated with the platform to contact service centers 2708 and arrange service scheduling 2718.

The methods and systems disclosed herein may provide several advantages. The methods and systems disclosed herein may enable a user to have a secured digital record of the product ownership information and for utilizing a service such as warranty entitlements for all the products purchased using a single user application such as, but not limited to, a mobile application and a software application. The user can manage the service from a wide range of user devices such as, but need not be limited to, a smart phone, a tablet, a personal computer, and a laptop. Further, the user can access the server at an online portal via a network such as Internet using web/mobile web browsers. All the information required for utilizing the service can be rendered via the user interface using the user application. Thus, the methods and systems disclosed herein obviates the need for a physical login process in order to connect with at least one of the one or more servers for accessing information associated with the product and the user. The methods and systems transform an object from a potentially uninsured state to an unambiguously insured state in which reference to the digital object assures a relevant party of a product being covered by the insurance. For example, storing a digital object on the computer system of an automobile product could confirm, upon inspection, that the automobile is insured, avoiding delays needed to check third party data sources for the same.

As one of the advantages of the methods and systems disclosed herein, the user device and the associated online account are always synchronized, as local databases of the user device, as well as the one or more servers can be updated during utilization of the service associated with the product. In a warranty service, entitlements associated with the product and warranty expiry information can proactively be notified to the user. Based on the notification, the user can selectively purchase extended warranties. Additionally, the methods and systems disclosed herein may provide the user with ready access to various post warranty product replacement deals that manufacturers and merchants offer. For example, the user can initiate a replacement purchase from the within the user application itself. Additional advantages may include enabling the user to schedule in-warranty entitlement services for products owned by the user from within the user application. Also, the methods and systems disclosed herein may enable the user to transfer ownership of product warranty, when the product is sold to a new owner. The methods and systems disclosed herein may enable the user to gain instant access to service history of a product. The methods and systems disclosed herein may enable the user to obtain a better resale value for used products with authenticated service history. The methods and systems disclosed herein may enable the user to sell used products using a built-in used-product cloud shop. The methods and systems disclosed herein may enable the user to obtain on demand availability of information on current product discounts offers, bundle deals and seasonal clearance sales. The methods and systems disclosed herein may enable the user to gain instant access to product manuals. The methods and systems disclosed herein may provide the user with a scribble-pad to take notes, while on call with the service center or service technician. The methods and systems disclosed herein may enable the user to gain instant access to product recalls information and follow-up reminders from product manufacturers. The methods and systems disclosed herein may enable the user to obtain driving directions to the service center by the press of a button. Additionally, the methods and systems disclosed herein may enable the user to maintain a social connection with all users of a particular product or a brand in order to exchange views, reviews, personal experiences and knowhow.

The methods and systems disclosed herein may provide several manufacturer advantages. The methods and systems disclosed herein may provide a manufacturer with instant up-to-date information and statistics on warranty entitlement services and paid product repair services, over the lifetime of all the products sold by the manufacturer. The methods and systems disclosed herein may enable the manufacturer to obtain a measurable increase in sale of extended warranties for the products. The methods and systems disclosed herein may provide the manufacturer with post-warranty offers and product replacement sales deals in order to achieve a measurable increase in product sales and to ensure continued consumer loyalty for the product and the brand. The methods and systems disclosed herein may provide the manufacturer with a reliable channel to extend consumer loyalty programs and services. The methods and systems disclosed herein may provide the manufacturer with direct B2C communication channel for businesses to communicate with the user, to conduct consumer surveys and polls, stream video advertisements and establish a new and dependable way to receive user feedback. Additionally, the methods and systems disclosed herein may enable the manufacturer to announce promotional product discounts, rebates and bundle offers and get immediate consumer attention. The methods and systems disclosed herein may provide the manufacturer with an increase in product and brand loyalty due to increased re-sale value of the products.

The methods and systems disclosed herein may provide advantages for extended warranty service providers. The methods and systems disclosed herein may enable extended warranty service providers to provide a reliable and dependable marketing channel to sell extended warranty services. The methods and systems disclosed herein may provide the extended warranty service providers with a direct B2C communication channel for businesses to communicate with the user, conduct user surveys and polls, stream video advertisements and to establish a new and dependable way to receive user feedback.

The methods and systems disclosed herein may provide several advantages for merchants. The methods and systems disclosed herein may provide merchants with a direct B2C communication channel for businesses to communicate with the user, conduct user surveys and polls, stream video advertisements and to establish a new and dependable way to receive user feedback. The methods and systems disclosed herein may provide the merchants with a reliable channel to extend user loyalty programs and services. The methods and systems disclosed herein may enable the merchants to announce promotional clearance sales, product discounts and bundle offers and to get immediate user attention. The methods and systems disclosed herein may enable the merchants to offer post-warranty services, product replacement sales deals in order to achieve measurable increase in product sales and to ensure continued consumer loyalty. Those skilled in the art will realize that the above recognized advantages and other advantages described herein are merely exemplary and are not meant to be a complete rendering of all of the advantages of the various embodiments of the methods and systems disclosed herein.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A system for utilizing a service associated with a product, the system comprising:
a user device of a user configured to:
collect a user information and a product information from the user; and
transmit the user information and the product information to a server; and
the server, wherein the server is configured to:
generate a digital object based on the user information and the product information, wherein the digital object comprises information for the user to utilize the service associated with the product; and
transfer the digital object to the user device for utilizing the service associated with the product, wherein transferring the digital object to the user transfers ownership of the product to the user.

2. The system of claim 1, wherein the service comprises an insurance service.

3. The system of claim 1, wherein the system comprises a plurality of layers, each layer secure for at least one provider of the service and a data center of the at least one provider.

4. The system of claim 3, wherein at least one layer comprises product information for at least one product or one brand, the at least one brand comprising a plurality of related products, the at least one layer allowing users to download information and an application (app) for the at least one product or one brand, the app suitable for a computer of the user.

5. The system of claim 3, wherein at least one layer comprises product information for a plurality of products or brands of a merchant, wherein a brand comprises a plurality of related products, the at least one layer allowing users to download information and an application (app) for at least one product or brand of the merchant, the app suitable for a computer of the user.

6. The system of claim 5, wherein the app is adapted for a user to organize products, brand apps and merchant apps.

7. The system of claim 1, wherein the system is adapted to allow an agent of a first plurality of providers of the service access to the plurality of layers of the first plurality of providers of the service, and wherein the system is adapted to allow the user of a second plurality of providers of the service access to the plurality of layers of the second plurality of providers of the service.

8. An article, comprising:
a secure digital object, the secure digital object containing product information and purchaser information received from a point of sale following a purchase of a product by a purchaser and containing service information for a service associated with the product; and
a wrapper for the secure digital object, the wrapper providing security for the secure digital object and adapted for delivery of the digital object to at least one of a device and an account of the purchaser and for management of access to the service by the purchaser using at least one of the device and the account.

9. The article of claim 8, wherein the secure digital object comprises proof of ownership of the product and proof of a right to access a warranty service associated with the product.

10. A system for utilizing a service associated with a product, the system comprising:
a user device configured to send an information of a user to a point of sale device at a time of purchase of the product; and
a point of sale device configured to:
collect the user information;
collect a product information at the time of purchase of the product; and
generate a digital object based on the user information and the product information, wherein the digital object comprises information for the user to utilize the service associated with the product; and
transfer the digital object to the user device for utilizing the service associated with the product, wherein transferring the digital object to the user device also transfers ownership of the product to the user.

11. The system of claim 10, wherein the digital object is a Binary Large Object (BLOB).

12. The system of claim 10, wherein the digital object is configured to:
automatically unwrap when placed in a digital container of the user device, wherein the digital container comprises an authentic cryptographic key; and
trigger a process in the user device to store information contained in the digital object on the user device.

13. A method, comprising:
receiving user information of a user and product information of a product collected at a point of sale;
storing the user information and product information;
generating a digital object based on the user information and the product information, wherein the digital object comprises information for using a service associated with the product; and
transferring the digital object to a user device, the digital object thereby adapted to transform an electronic data structure of the user device such that the user device operates as a token of ownership of the product by the user and as an authenticated access token for a service associated with the product.

14. The method of claim 13, wherein receiving the user information comprises at least one of:
receiving a manual input corresponding to the user information collected at the point of sale; and
receiving the user information from the user device via at least one of near field communication, Wi-Fi, and iBeacon™.

15. The method of claim 13, wherein receiving the product information comprises at least one of:
receiving a manual input corresponding to the product information collected at the point of sale; and
receiving an identifier corresponding to the product, the identifier collected at the point of sale.

16. The method of claim 13, wherein generating the digital object associates the product with a user account, wherein the product is associated with the user account based on the user information received at the point of sale.

17. The method of claim 13, wherein generating the digital object comprises validating the user information and the product information and wherein the digital object is a read-only digital object.

18. The method of claim 13, wherein generating the digital object comprises encapsulating the digital object in a secure digital wrapper.

19. The method of claim 18, wherein transferring the digital object to the user device comprises unwrapping the digital object at the user device and storing the information obtained from the digital object in a data storage facility of the user device.

20. The method of claim 19 further comprising synchronizing the information stored on the user device with a user account hosted in a cloud computing environment.

21. The method of claim 13, wherein the service associated with the product is a warranty service and wherein the digital object is programmable to execute at least one predefined function for the user to receive the service.

22. The method of claim 21, further comprising connecting with a product reverse logistics process using the warranty service.

23. The method of claim 21, further comprising granting access to a merchant or a product service provider to the user information and product information stored at the secure server of the manufacturer of the product.

24. The method of claim 13, wherein the service associated with the product is a warranty service and further comprising presenting the warranty service and warranty information associated with the product to at least one of the user device and a user account of the user.

25. The method of claim 24, further comprising transferring the warranty service associated with the product to a second user, wherein transferring the warranty service comprises transferring the digital object from the user device to a second user device associated with the second user and wherein transferring the warranty service associated with the product to the second user functions as a transfer of ownership of the product to the second user.

26. The method of claim 25 further comprising updating a database of a stakeholder associated with the product in response to transfer of the warranty service to the second user.

27. The method of claim 26, wherein the stakeholder is selected from the group consisting of a manufacturer, a warranty service provider, an entitlement service provider, a repair provider, a vendor and an insurance company.

28. The method of claim 13, further comprising presenting at least one of an extended warranty and an additional entitlement from a service provider and updating metadata within the digital object with information associated with purchase of at least one of the extended warranty and the additional entitlement.

29. The method of claim 28 further comprising updating a database of a stakeholder associated with the product in response to the purchase of one of the extended warranty and the additional entitlement, the stakeholder selected from the group consisting of a manufacturer, a warranty service provider, an entitlement service provider, a repair provider, a vendor and an insurance company.

30. The method of claim 13, wherein the electronic data structure further comprises two or more items of data selected from the group consisting of a warranty, a service history, a product manual, an invoice a cryptographic key and product related media.

31. The method of claim 13, further comprising storing the user information and product information at a secure server of a manufacturer of the product.

32. A method for a user to utilize a service associated with a product, the method comprising:
receiving a user information and a product information from the user via a user device, wherein the user information and the product information is collected at a point of sale;
generating a digital object based on the user information and the product information, wherein the digital object comprises information for the user to utilize the service associated with the product; and
transferring the digital object to the user device to allow the user to utilize the service associated with the product, wherein transferring the digital object operates to transfer ownership of the product to the user and wherein the digital object acts as an authenticated access token for the service associated with the product.

33. The method of claim 32, further comprising storing the user information and product information at a secure server of a manufacturer of the product.

34. The method of claim 32, further comprising accepting an app plug into the user device before transferring the digital object to the user device.

35. The method of claim 32, wherein the service associated with the product comprises a digital warranty for the product and further comprising, after the step of transferring, downloading to the digital object at least one of a remote control program for the product, a video or media presentation concerning the product and a support Wizard for the product.
